(19) United States
(12) Patent Application Publication
(10) Pub. No.: US 2025/0071570 A1
(43) Pub. Date: Feb. 27, 2025

(54) ELECTRONIC DEVICE, COMMUNICATION METHOD AND COMPUTER PROGRAM PRODUCT

(71) Applicant: Sony Group Corporation, Tokyo (JP)

(72) Inventor: Jianfei CAO, Beijing (CN)

(73) Assignee: Sony Group Corporation, Tokyo (JP)

(21) Appl. No.: 18/726,417

(22) PCT Filed: Jan. 9, 2023
(86) PCT No.: PCT/CN2023/071295

§ 371 Date: Jul. 3, 2024

(30) Foreign Application Priority Data
Jan. 13, 2022 (CN) 202210034245.0

(51) Int. Cl. H04W 16/28; H04B 7/06; H04W 72/231; H04W 76/20; H04W 80/02

(52) U.S. Cl. CPC H04W 16/28; H04B 7/06968; H04W 72/231; H04W 76/20; H04W 80/02

(57) ABSTRACT

An electronic device for a base station includes processing circuitry configured to configure, via RRC signaling, a transmission configuration indication (TCI) state pool for a user equipment (UE); activate, via MAC CE including a set of codepoints, TCI states in the TCI state pool for the UE, wherein each of the codepoints is capable of referencing any of
a) a single downlink TCI state for indicating a downlink beam; b) a single uplink TCI state for indicating an uplink beam; c) a single joint TCI state for indicating a downlink beam and an uplink beam; or d) a pair of uplink TCI state and downlink TCI state; and indicate, via a DCI pointing to one codepoint of the set of codepoints, use of a beam corresponding to a TCI state referenced by this codepoint to the UE.

### FIELD OF THE INVENTION

The present disclosure relates to the field of wireless communication, and more particularly, to an electronic device, a communication method, and a computer program product that provide an improved beam indication mechanism to increase flexibility thereof.

### BACKGROUND

The 5G New Radio (NR) introduces in Release 15 a concept of transmission configuration indication (TCI) state for defining and indicating quasi co-location (QCL) relationship between two reference signals. Each TCI state may contain a QCL assumption of four types, namely QCL-TypeA, QCL-TypeB, QCL-TypeC, and QCL-TypeD, and a user equipment (UE) may infer time-domain, frequency-domain, and/or spatial-domain parameters of one reference signal from another reference signal based on respective QCL assumption, enabling reception of an upcoming reference signal using the parameters of the another reference signal that was previously received. It is essence of the QCL. Wherein a TCI state containing the QCL-TypeD assumption may be used for indication of a spatial beam.

According to current discussions of the 3GPP Release 17, a base station may configure a UE with either a joint TCI state, i.e., one TCI state applicable to both uplink and downlink channels and/or signals, or a separate TCI state, i.e., an uplink TCI state applicable to only an uplink channel and/or signal and a downlink TCI state applicable to only a downlink channel and/or signal.

These two types of TCI states both have their advantages and disadvantages. However, current standard protocols do not support hybrid configuration of different types of TCI states, and also lack a signaling format that supports the beam indication using them at the same time. This means that when switching from one type of TCI state to another, higher-level configuration of the TCI states needs to be performed again, resulting in longer latency and more signaling consumption.

Therefore, there is a need for a beam indication mechanism that can utilize various types of TCI states at the same time so as to provide flexibility thereof.

### SUMMARY OF THE INVENTION

The present disclosure provides a number of aspects. The above-described need may be met by applying one or more aspects of the present disclosure.

A brief summary regarding the present disclosure is given here to provide a basic understanding on some aspects of the present disclosure. However, it will be appreciated that the summary is not an exhaustive description of the present disclosure. It is not intended to identify key portions or important portions of the present disclosure, nor to limit the scope of the present disclosure. It aims at merely describing some concepts about the present disclosure in a simplified form and serves as a preorder of a more detailed description to be given later.

According to one aspect of the present disclosure, there is provided an electronic device for a base station, comprising:
processing circuitry configured to
   configure, via RRC signaling, a transmission configuration indication (TCI) state pool for a user equipment (UE);
   activate, via MAC CE including a set of codepoints, TCI states in the TCI state pool for the UE, wherein each of the codepoints is capable of referencing any of
      a) a single downlink TCI state for indicating a downlink beam;
      b) a single uplink TCI state for indicating an uplink beam;
      c) a single joint TCI state for indicating a downlink beam and an uplink beam; or
      d) a pair of uplink TCI state and downlink TCI state; and
   indicate, via a DCI pointing to one codepoint of the set of codepoints, use of a beam corresponding to a TCI state referenced by this codepoint to the UE.

According to one aspect of the present disclosure, there is provided an electronic device for a user equipment (UE), comprising:
processing circuitry configured to
   receive RRC signaling for configuration on a transmission configuration indication (TCI) state pool from a base station;
   receive a MAC CE including a set of codepoints to activate TCI states in the TCI state pool from the base station, wherein each of the codepoints is capable to reference any of
      a) a single downlink TCI state for indicating a downlink beam;
      b) a single uplink TCI state for indicating an uplink beam;
      c) a single joint TCI state for indicating a downlink beam and an uplink beam; or
      d) a pair of uplink TCI state and downlink TCI state; and
   receive a DCI pointing to one codepoint of the set of codepoints from the base station, so as to be indicated use of a beam corresponding to a TCI state referenced by the codepoint.

According to one aspect of the present disclosure, there is provided a communication method, comprising:
configuring, via RRC signaling, a transmission configuration indication (TCI) state pool for a user equipment (UE);
activating, via MAC CE including a set of codepoints, TCI states in the TCI state pool for the UE, wherein each of the codepoints is capable of referencing any of
   a) a single downlink TCI state for indicating a downlink beam;
   b) a single uplink TCI state for indicating an uplink beam;
   c) a single joint TCI state for indicating a downlink beam and an uplink beam; or
   d) a pair of uplink TCI state and downlink TCI state; and
indicating, via a DCI pointing to one codepoint of the set of codepoints, use of a beam corresponding to a TCI state referenced by this codepoint to the UE.

According to one aspect of the present disclosure, there is provided a communication method, comprising:
receiving RRC signaling for configuration on a transmission configuration indication (TCI) state pool from a base station;
receiving a MAC CE including a set of codepoints to activate TCI states in the TCI state pool from the base station, wherein each of the codepoints is capable to reference any of
   a) a single downlink TCI state for indicating a downlink beam;
   b) a single uplink TCI state for indicating an uplink beam;
   c) a single joint TCI state for indicating a downlink beam and an uplink beam; or
   d) a pair of uplink TCI state and downlink TCI state; and
receiving a DCI pointing to one codepoint of the set of codepoints from the base station, so as to be indicated use of a beam corresponding to a TCI state referenced by the codepoint.

According to one aspect of the present disclosure, there is provided a computer program product comprising executable instructions which, when executed, implement any of the above communication methods.

### DESCRIPTION OF THE DRAWINGS

A better understanding of the present disclosure may be achieved by referring to a detailed description given hereinafter in connection with accompanying drawings, wherein the same or similar reference signs are used to indicate the same or similar elements throughout the drawings. The drawings are to be included in the specification and form a part of the specification along with the following detailed descriptions, for further illustrating embodiments of the present disclosure and for explaining the theory and advantages of the present disclosure. Wherein,

FIG. 1 illustrates a simplified diagram of architecture of an NR communication system;

FIGS. 2A and 2B illustrate NR radio protocol stacks for a user plane and a control plane, respectively;

FIG. 3 is a schematic configuration diagram illustrating a TCI state;

FIG. 4 illustrates a beam indication process based on separate TCI states;

FIG. 5 illustrates a beam indication process based on joint TCI states;

FIG. 6 illustrates a beam indication process according to a first embodiment;

FIG. 7 illustrates a MAC CE format for activating TCI states;

FIG. 8 illustrates a Downlink Control Information (DCI) format for indicating a TCI state;

FIG. 9 illustrates a beam indication process according to a second embodiment;

FIG. 10 illustrates a beam indication process according to a third embodiment;

FIG. 11 illustrates a MAC CE format for selecting a TCI state pool;

FIG. 12 illustrates a beam indication process according to a fourth embodiment;

FIG. 13 illustrates a MAC CE format for activating TCI states;

FIG. 14 illustrates a beam indication process according to a fifth embodiment;

FIG. 15 illustrates a MAC CE format for selecting a TCI state pool;

FIG. 16 illustrates a MAC CE format for enabling a combination of channels or reference signals;

FIGS. 17A and 17B illustrate an electronic device on the base-station side and a communication method thereof according to the embodiments;

FIGS. 18A and 18B illustrate an electronic device on the UE side and a communication method thereof according to the embodiments;

FIG. 19 illustrates a first example of schematic configuration of the base station according to the present disclosure;

FIG. 20 illustrates a second example of schematic configuration of the base station according to the present disclosure;

FIG. 21 illustrates an example of schematic configuration of a smart phone according to the present disclosure; and

FIG. 22 illustrates an example of schematic configuration of an automobile navigation device according to the present disclosure.

Further features and aspects of the present disclosure will become apparent from the following description with reference to the attached drawings.

### DETAILED DESCRIPTION OF PREFERRED EMBODIMENTS

Various illustrative embodiments of the present disclosure will be described hereinafter with reference to the drawings. For purpose of clarity and simplicity, not all implementations of the embodiments are described in the specification. Note that, however, many settings specific to the implementations can be made in practicing the embodiments of the present disclosure according to specific requirements, so as to achieve specific goals of the developers, for example, to comply with constraints related to the device or business, which may vary from implementations.

In addition, it should be noted that to avoid obscure the present disclosure with unnecessary details, the figures illustrate only steps of a process and/or components of a device that are closely related to the technical solutions according to the present disclosure, and omit details that have little relation to the present disclosure.

For convenient explanation of the technical solutions of the present disclosure, various aspects of the present disclosure will be described below in context of the 5G NR. However, it should be noted that this is not a limitation on the scope of application of the present disclosure. One or more aspects of the present disclosure can also be applied to commonly used wireless communication systems, such as the 4G LTE/LTE-A, or various wireless communication systems to be developed in future. The architecture, entities, functions, processes and the like as described in the following description are not limited to those in the NR communication system, and can be found in other communication standards.

### Overview

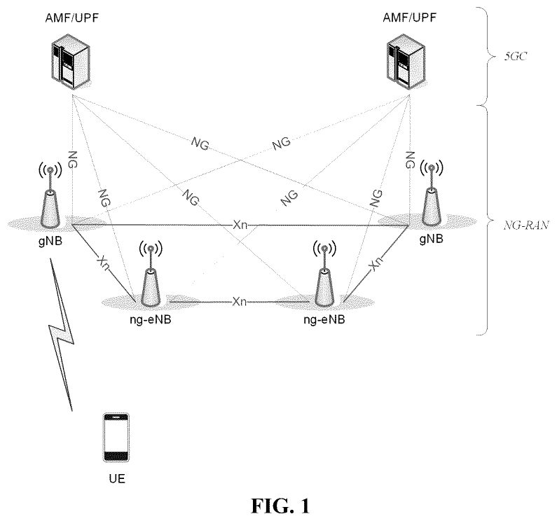

FIG. 1 is a simplified diagram illustrating an architecture of the NR communication system. As shown in FIG. 1, on the network side, radio access network (NG-RAN) nodes of the NR communication system include gNBs and ng-eNBs, wherein the gNB is a newly defined node in the 5G NR communication standard, and it is connected to a 5G core network (5GC) via a NG interface, and provides NR user plane and control plane protocols terminating with a terminal equipment (also referred to as “user equipment”, hereinafter simply referred to as “UE”); the ng-eNB is a node defined to be compatible with the 4G LTE communication system, and it may be upgradation of an evolved Node B (eNB) of the LTE radio access network, is connected to a 5G core network via a NG interface, and provides user plane and control plane protocols for evolved universal terrestrial radio access (E-UTRA) terminating with the UE. Hereinafter, the gNB and ng-eNB are collectively referred to as “base station”.

It should be noted that the “base station” used in the present disclosure is not limited to the above two types of nodes, but encompasses various control devices on the network side, and has a full breadth of its usual meaning. For example, in addition to the gNB and ng-eNB specified in the 5G communication standard, depending on scenarios in which the present disclosure is applied, the “base station” may also be, for example, an eNB, a remote radio head, a wireless access point, or a communication device that performs similar functions. Application examples of the base station will be described in detail in the following section.

Moreover, in the present disclosure, the term “UE” has a full breadth of its usual meaning, including various terminal devices communicating with the base station. As an example, the UE may be a mobile phone, a laptop, a tablet, an in-vehicle communication device, or an element thereof. Application examples of the UE will be described in detail in the following section.

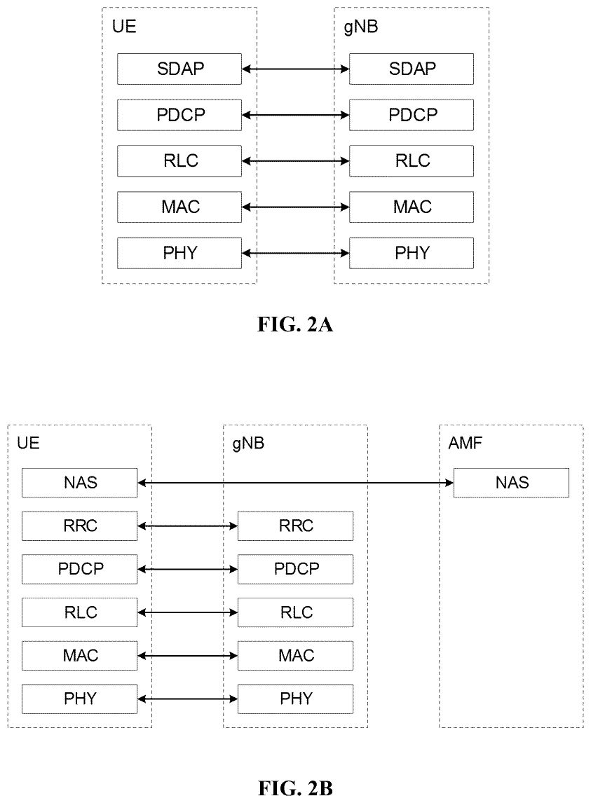

FIGS. 2A and 2B illustrate NR radio protocol stacks for the user plane and the control plane, respectively. The radio protocol stacks are shown to have three layers: Layer 1, Layer 2 and Layer 3.

Layer 1 (L1) as the lowest layer is also called a physical layer, and implements various physical-layer signal processing to provide transparent transmission for signals. L1 provides physical transport channels for upper layers.

Layer 2 (L2) is above the physical layer and is responsible for managing links above the physical layer. In the user plane and the control plane, L2 includes a medium access control (MAC) sublayer, a radio link control (RLC) sublayer, and a packet data convergence protocol (PDCP) sublayer. In the user plane, a service data adaptation protocol (SDAP) sublayer is also included in the UE and the base station.

In the control plane, Layer 3 (L3), namely, Radio Resource Control (RRC) layer, is also included in the UE and the base station. The RRC layer is responsible for obtaining radio resources and for configuring lower layers using RRC signaling between the base station and the UE. In addition, the UE performs functions such as authentication, mobility management, security control and the like with a non-access stratum (NAS) control protocol in a core network (AMF).

In a wireless communication system such as the 5G NR, both the base station and the UE have many antennas, for example, several, tens, hundreds, or even thousands of antennas, to support application of multiple input multiple output (MIMO) technology. An antenna model is generally defined with mapping relationship of three tiers around the antennas, so that it can smoothly undertake the channel model and the communication standard.

The lowest tier is the most basic physical unit, namely, antennas (also called antenna elements). Each of the antenna elements radiates electromagnetic waves according to respective amplitude parameter and phase parameter.

The antenna elements are arranged into one or more antenna arrays in a matrix form. One antenna array can be composed of antenna elements of an entire row, an entire column, multiple rows and multiple columns. At this tier, each antenna array actually constitutes a transmit-receive unit (TXRU). Each TXRU is independently configurable. Adjustment of an antenna pattern of the TXRU is implemented by configuring beamforming parameters (amplitude parameters and/or phase parameters) of the antenna elements constituting the TXRU, so that the electromagnetic wave radiations emitted by all of the antenna elements in the antenna array form a narrow beam pointing to a specific spatial direction, that is, beamforming is implemented.

Finally, one or more TXRUs construct an antenna port seen at the system tier through logical mapping. The “antenna port” is defined such that a channel carrying a symbol on one antenna port can be inferred from a channel carrying another symbol on the same antenna port.

Due to different locations, different distances from the UE, different signal paths or the like, signals on different antenna ports may have significantly different large-scale properties. However, if a distance between antenna ports is not significant, and the antenna ports located at different locations may have similar large-scale properties, it can be assumed that these antenna ports are quasi co-located (QCL), and have the same large-scale properties. This means that when two antenna ports are quasi co-located, the channel large-scale property parameters estimated from a signal on one antenna port are also applicable to a signal on the other antenna port.

The large-scale property includes at least one of: a delay spread, a doppler spread, a doppler shift, an average gain, an average delay, and spatial reception parameters. In particular, if two antenna ports have a QCL relationship with respect to spatial reception parameters, the receiving side may use the same spatial reception parameters to achieve signal reception on the two antenna ports. As used in the present disclosure, the “spatial reception parameters” include beamforming parameters for forming a reception beam to achieve optimal reception for radio signals from a particular spatial direction. Correspondingly, when the antenna array is configured with these beamforming parameters for transmission, a transmission beam pointing to the particular spatial direction may be formed. In the present disclosure, for simplicity of description, sometimes the transmission beam and the reception beam are not distinguished, and will be collectively referred to as “beam”, and whether to be used for transmission or reception may be known in conjunction with the context.

The antenna port may be characterized by a reference signal, such as a Synchronization Signal Block (SSB), a Channel State Information Reference Signal (CSI-RS), Sounding Reference Signal (SRS) and the like, which may be used for channel estimation or for processing physical channels transmitted on the same antenna port. There is one-to-one correspondence between the antenna port and its reference signal. As such, when two antenna ports are referred to be QCL-ed in the following, it may be directly said that there is a QCL relationship between the two reference signals characterizing them and/or the transmission channels multiplexed with the reference signals.

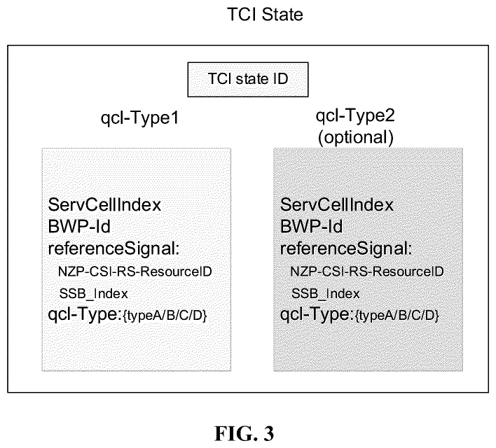

Typically, the base station may indicate the QCL relationship to the UE using a TCI state. FIG. 3 is a configuration diagram illustrating the TCI state. As shown in FIG. 3, the TCI state is identified by a TCI state ID. Each TCI state contains a QCL assumption for configuring one or two reference signals with a transmission channel, such as a Physical Downlink Control Channel (PDCCH), a Physical Downlink Shared Channel (PDSCH), a Physical Uplink Control Channel (PUCCH), a Physical Uplink Shared Channel (PUSCH) or the like, or with a reference signal, such as a demodulation reference signal (DMRS), a Sounding Reference Signal (SRS) or the like. For the first reference signal, such QCL relationship is configured by qcl-Type1. If there is a second downlink reference signal, the QCL relationship is configured by an optional qcl-Type2. As shown in FIG. 3, qcl-Type1 or qcl-Type2 includes the following information:
serving cell index (ServCellIndex), which represents a serving cell where the reference signal is located;
bandwidth part ID (BWP-Id), which represents a downlink bandwidth part where the reference signal is located;
reference signal (referenceSignal), which represents a source reference signal resource providing QCL information, including a NZP-CSI-RS resource identified by NZP-CSI-RS-ResoureId, a SSB resource identified by SSB-Index, or the like;
QCL type (qcl-Type), which represents a QCL type corresponding to the listed reference signal, including QCL-TypeA, QCL-TypeB, QCL-TypeC, and QCL-TypeD. Among them, QCL-TypeD is related to spatial reception parameters, and in the beam indication process described in the present disclosure, the mentioned TCI state includes a QCL assumption of QCL-TypeD.

For avoidance of ambiguity, each TCI state is typically allowed to contain only one QCL assumption of the type QCL-TypeD. When the UE receives such TCI state, the UE makes the following QCL assumption: the antenna port of the reference signal listed in the TCI state has a QCL relationship with respect to spatial reception parameters with the antenna port of the channel or the reference signal for which the TCI state is intended, so that the UE can receive a desired downlink channel or reference signal using a beam previously receiving the listed reference signal or, based on symmetry between the uplink beam and the downlink beam, the UE can transmit an uplink channel or reference signal using a beam previously receiving the listed reference signal.

For the uplink and the downlink, the current beam indication mechanism mainly includes two patterns, that is, based on separate TCI states and based on joint TCI states.

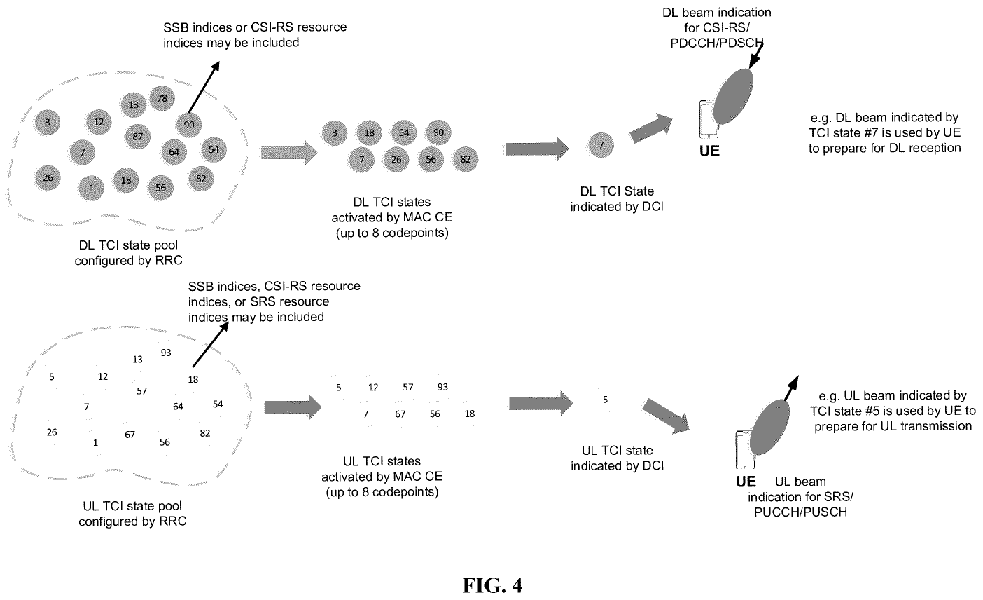

FIG. 4 shows a beam indication process based on separate TCI states. For the downlink, as shown in the upper part of FIG. 4, the base station configures, via RRC signaling, a DL TCI state pool including only TCI states for indicating downlink beams (referred to as “downlink TCI states” or “DL TCI states” in the present disclosure) for the UE, then activates up to 8 DL TCI states using a MAC CE, and then indicates one of the activated DL TCI states (e.g., TCI state #7) using a DCI, so that the UE can prepare for reception of, for example, a PDCCH, a PDSCH or a CSI-RS using a downlink beam indicated by the TCI state. For the uplink, as shown in the lower part of FIG. 4, the base station configures, via RRC signaling, a UL TCI state pool including only TCI states for indicating uplink beams (referred to as “uplink TCI states” or “UL TCI states” in the present disclosure) for the UE, then activates up to 8 UL TCI states using a MAC CE, and then indicates one of the activated UL TCI states (e.g., TCI state #5) using a DCI, so that the UE can prepare transmission of, for example, a PUCCH, a PUSCH, or an SRS using a downlink beam indicated by the TCI state.

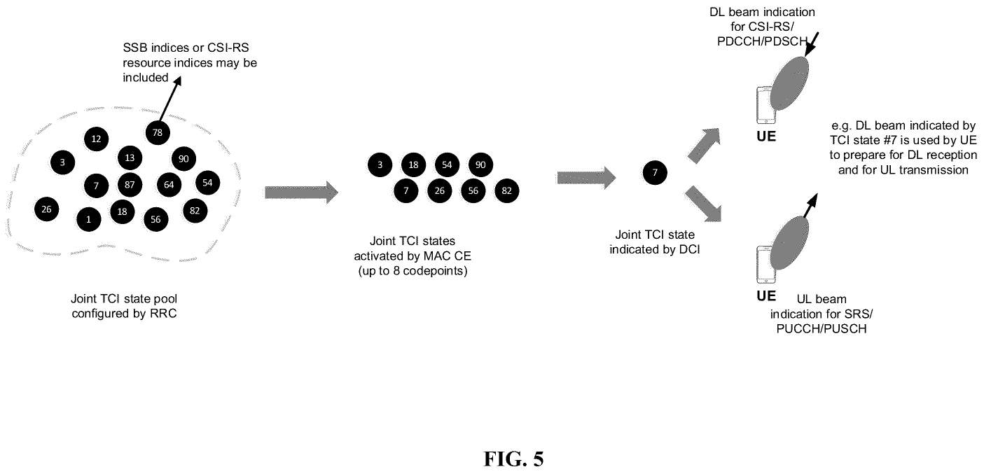

FIG. 5 illustrates a beam indication process based on joint TCI states. As shown in the upper part of FIG. 5, the base station configures, via RRC signaling, a joint TCI state pool for the UE, where each TCI state (referred to as “joint TCI state” herein) can be used to indicate an uplink beam and a downlink beam at the same time. Then, the base station activates up to 8 joint TCI states using a MAC CE, and then indicates one of the activated joint TCI states (e.g., TCI state #7) using a DCI, so that the UE can prepare for reception of a downlink channel (e.g., PDCCH, PDSCH) or a downlink reference signal (e.g., CSI-RS) and transmission of an uplink channel (e.g., PUCCH, PUSCH) or an uplink reference signal (e.g., SRS) using a beam indicated by the TCI state.

The inventors of the present disclosure have noted that there are deficiencies with the existing beam indication mechanisms. On the one hand, if the separate TCI states are used, the uplink beam indication and the downlink beam indication are independent of each other, and even if symmetric beams can be used for the uplink and the downlink, separate beam indication procedures still need to be performed. On the other hand, if the joint TCI states are used, the uplink and the downlink always use symmetric beams, which may not meet actuals need for uplink and downlink transmissions. Switching between different beam indication patterns requires reconfiguration of the TCI state pool, which results in increased latency and signaling burden.

In view of these, the present disclosure provides a unified beam indication mechanism, which uses a set of general processes to meet different beam indication requirements, thereby improving flexibility of the beam management in various application scenarios. Various aspects of the present disclosure will be described with reference to exemplary embodiments, but it should be understood that the embodiments of the present disclosure can be implemented individually or in any combination, that is, any combination of two or more embodiments is also within the scope of the present disclosure.

### First Embodiment

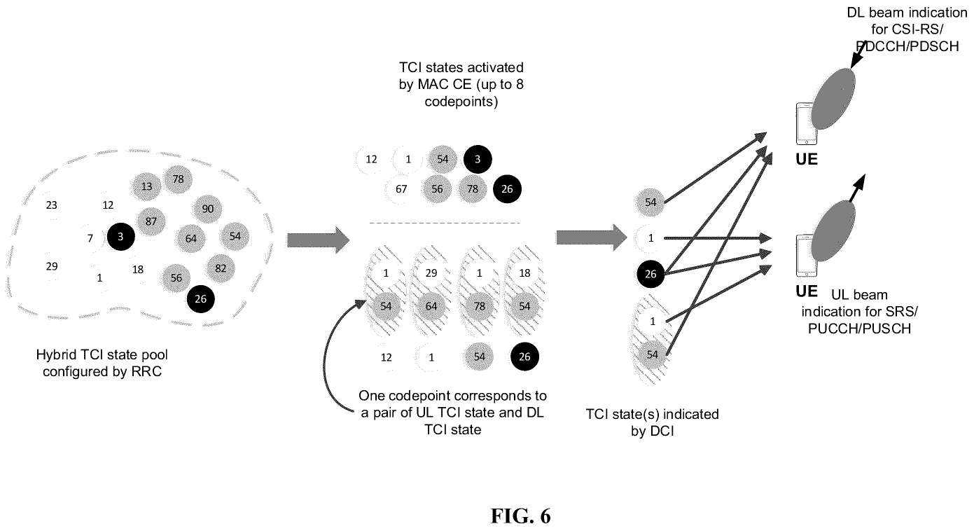

FIG. 6 illustrates a unified beam indication process according to a first embodiment of the present disclosure. In FIG. 6, the TCI states are denoted using differently filled circles, with numbers therein representing TCI state IDs, but it should be understood that the number, type, numbering or the like of TCI states as illustrated are merely illustrative and do not limit the scope of protection.

The beam indication process according to the first embodiment may be divided into three phases, namely, RRC configuration, MAC CE activation, and DCI indication. It is substantially consistent with the beam indication process commonly used for data channels (such as PDSCH, PUSCH) in the existing standard protocols. However, for control channels such as PUCCH, PDCCH or the like, the MAC CE for activating the TCI state may activate only one TCI state in the TCI state pool, so that no further indication with a DCI is required, that is, the subsequent DCI indication phase may be omitted. Therefore, the beam indication process of the present disclosure is also applicable to a scenario in which the uplink beam and/or the downlink beam for the UE is directly indicated by using the MAC CE, and the description will not be repeated below.

As shown in FIG. 6, in the RRC configuration phase, the base station may configure one TCI state pool, which includes no more than a predetermined number (e.g., 128) of TCI states, for the UE via RRC signaling.

The RRC signaling refers to an Information Element (IE) configured at the RRC layer. For example, for the PDSCH, the base station may add or modify TCI states in the TCI state pool by configuring a parameter tci-StatesToAddModList in PDSCH-Config information element as shown below, or delete TCI states in the TCI state pool by configuring a parameter tci-StatesToReleaseList. Similarly, the base station may configure the TCI state pool for the PDCCH by setting parameters of an information element ControlResourceSet, and so on.

| | |
|---|---|
| PDSCH-Config ::= | SEQUENCE { |

...

| | |
|---|---|
| tci-StatesToAddModList | SEQUENCE (SIZE(1..maxNrofTCI-States)) OF |
| TCI-State | OPTIONAL, -- Need N |
| tci-StatesToReleaseList | SEQUENCE (SIZE(1..maxNrofTCI-States)) OF TCI- |
| StateId | OPTIONAL, -- Need N |

According to the first embodiment of the present disclosure, the TCI state pool configured via RRC may include different types of TCI states, for example, including any two or three types of joint TCI states, uplink TCI states, and downlink TCI states. In other words, unlike a conventional TCI state pool that includes only one type of TCI states, for example, the first embodiment of the present disclosure may configure the UE with a hybrid TCI state pool including joint TCI states (as shown by the dark circles with numbers 3, 26), uplink TCI states (as shown by the open circles with numbers 12, 23, 29, etc.), and downlink TCI states (as shown by the light circles with numbers 13, 78, 54, etc.), as shown in FIG. 6.

Each of the TCI states may contain an index of corresponding reference signal to provide QCL source information, and as previously described, the reference signal actually corresponds to a beam for receiving or transmitting the reference signal at the UE. For example, the downlink TCI state may include a CSI-RS resource index or an SSB index, such that the downlink TCI state may indicate a UE downlink reception beam for receiving the CSI-RS or SSB; the uplink TCI state may include a CSI-RS resource index, an SSB index, or an SRS resource index, and thus the uplink TCI state may indicate an uplink transmission beam symmetric to a UE downlink reception beam for receiving the CSI-RS or SSB, or a UE uplink transmission beam for transmitting the SRS; the joint TCI state may include a CSI-RS resource index or an SSB index, whereby the downlink TCI state may indicate a UE downlink reception beam for receiving this CSI-RS or SSB as well as a symmetric uplink transmission beam.

The base station may employ various policies to configure the TCI state pool. Generally, based on predictions of a moving direction and a moving speed of the UE, putting TCI states corresponding to beams that are likely to be used by the UE on the moving trajectory into the pool helps to improve the efficiency of beam indication. The base station may also dynamically add, modify, or delete TCI states in the TCI state pool.

Preferably, the base station may further configure, via RRC signaling, whether each of the TCI states is applicable to an uplink channel or reference signal, a downlink channel or reference signal, or both, that is, whether each of the TCI states is an uplink TCI state, a downlink TCI state, or a joint TCI state. More preferably, each of the TCI states may also be specifically configured to be applicable to which channel(s) or reference signal(s), and this is especially advantageous for the case of indication with a DCI that has no function of scheduling or triggering. However, if the DCI itself is used, for example, for scheduling a PDSCH or for triggering an aperiodic CSI-RS, the UE may know that the TCI state indicated in the DCI is applicable to the scheduled PDSCH or the triggered aperiodic CSI-RS, and thus does not need to be configured with the type of the TCI state in advance.

Next, during the MAC CE activation phase, the base station may activate one or more TCI states in the TCI state pool using a MAC CE. The number of activatable TCI states does not exceed the number of codepoints in the MAC CE, for example, 8. For example, the activated TCI states may correspond to beams that are predicted to be used by the UE in the movement for a future period of time.

Compatible with existing standard protocols, the MAC CE according to the present disclosure may reference one TCI state in each codepoint, as shown in FIG. 6, 8 codepoints of the MAC CE may reference TCI states #12, #1, #54, #3, #67, #56, #78, #26, respectively, in which, for example, TCI states #12, #1 and #67 are uplink TCI states, TCI states #54, #56 and #78 are downlink TCI states, and TCI states #3 and #26 are joint TCI states, for example.

In addition, some or all of the codepoints in the MAC CE according to the present disclosure may also reference a pair of uplink TCI state and downlink TCI state. For example, as shown in FIG. 6, four codepoints of the MAC CE may reference a pair of uplink TCI state #1 and downlink TCI state #54, a pair of uplink TCI state #29 and downlink TCI state #64, a pair of uplink TCI state #1 and downlink TCI state #78, and a pair of uplink TCI state #18 and downlink TCI state #54, respectively, while the other four codepoints may reference a single TCI state #12 (downlink), #1 (uplink), #54 (downlink), and #26 (jointed), respectively.

Whether a codepoint of the MAC CE activates a single TCI state or a pair of TCI states depends on actual needs. For example, the base station may predict that the uplink transmission beam (or downlink reception beam) currently used by the UE does not need to be changed later, and may activate only a single downlink TCI state (or uplink TCI state) corresponding to the downlink reception beam (or uplink transmission beam) that needs to be changed. Alternatively, the base station may predict that both of the uplink transmission beam and the downlink reception beam currently used by the UE may be changed, and may activate TCI states corresponding to the two beams at the same time, wherein if the UE may use symmetric uplink and downlink beams, a joint TCI state (e.g., TCI state #26) corresponding to them may be activated, otherwise a pair of uplink TCI state (e.g., TCI state #1) indicating an uplink beam and downlink TCI state (e.g., TCI state #54) indicating a downlink beam may be activated.

FIG. 7 shows an example format of the MAC CE according to the first embodiment. The MAC CE shown in FIG. 7 may include the following fields:
“R”, a reserved field;
“Serving Cell ID”, which represents a serving cell to which the MAC CE applies;
“BWP ID”, which represents a downlink BWP to which the MAC CE applies;
“C_{N}”, which represents whether there is an octet containing an optional TCI state ID, where N is an index of the codepoint. For example, for the 1st codepoint (‘000’), it indicates that there is a TCI state ID_{0,2} if C₀ is set to 1, otherwise there is not TCI state ID_{0,2} if C₀ is set to 0, and so on;
“TCI state ID_{N,1}”, “TCI state ID_{N,2}”, which represent activated TCI states, where N is an index of the codepoint. The TCI state ID field takes 7 bits and thus can indicate up to 128 TCI states. In a case where a pair of TCI states need to be activated, it may be signaled in advance that TCI state ID_{N,1} indicates an uplink TCI state, and TCI state ID_{N,2} indicates a downlink TCI state, or vice versa, enabling the UE to distinguish the two TCI states. Alternatively, settings according to such correspondence may not be made if the RRC signaling already configures the types of the TCI states.

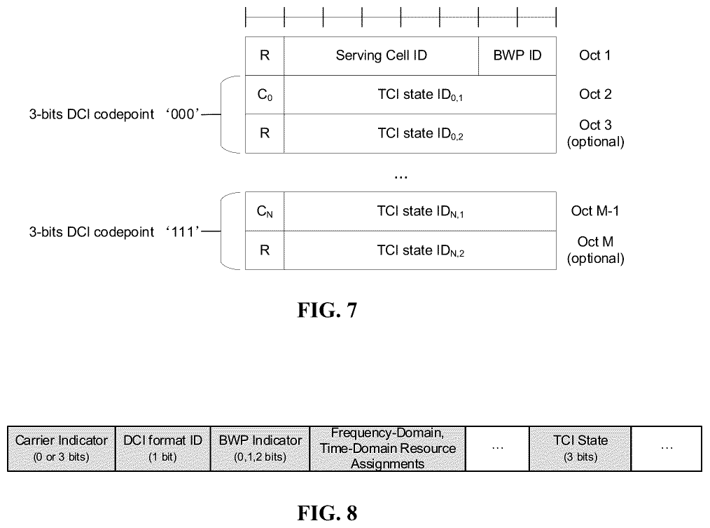

Finally, in the DCI indication phase, the base station may indicate one of the activated TCI states to the UE using a DCI as shown in FIG. 8. As shown in FIG. 8, the DCI includes a TCI state field of 3 bits, for example, in addition to a carrier indicator, a BWP indicator, and resource assignment information. The TCI state field may point to any one of the codepoints of the MAC CE, for example, the field value “000” points to the 1st codepoint of the MAC CE, the field value “001” points to the 2nd codepoint of the MAC CE, and so on.

The UE may extract corresponding TCI state ID(s) from the MAC CE based on the value of the TCI state field in the DCI, find corresponding TCI state(s), and determine a beam or beams for downlink reception and/or uplink transmission based on the TCI state.

For ease of illustration, various scenarios are described next in connection with the example shown in FIG. 6:
1) if the TCI state field in the DCI points to a MAC CE codepoint referencing a single downlink TCI state, such as TCI state #54, the UE may prepare for downlink reception of, for example, a CSI-RS, a PDCCH, or a PDSCH by using a beam corresponding to the downlink TCI state. The downlink channel or reference signal to which the downlink TCI state applies may be configured in advance, or may be determined according to a scope of the DCI, for example, a TCI state in a DCI for scheduling a PDSCH is used to determine a beam for receiving the PDSCH, and so on;
2) if the TCI state field in the DCI points to a MAC CE codepoint referencing a single uplink TCI state, such as TCI state #1, the UE may prepare for uplink transmission of, for example, a SRS, a PUCCH, or a PUSCH by using a beam corresponding to the uplink TCI state. Similarly, the uplink channel or reference signal to which the uplink TCI state applies may be configured in advance, or may be determined according to a scope of the DCI, for example, a TCI state in a DCI for scheduling a PUSCH is used to determine a beam for transmitting the PUSCH, and so on;
3) if the TCI state field in the DCI points to a MAC CE codepoint referencing a single joint TCI state, such as TCI state #26, the UE may prepare for downlink reception of, for example, a CSI-RS, a PDCCH, or a PDSCH, and for uplink transmission of, for example, a SRS, a PUCCH, or a PUSCH, by using beams corresponding to the joint TCI state. Similarly, the downlink channel or reference signal to which the joint TCI state applies may be configured in advance, or may be determined according to a scope of the DCI;
4) if the TCI state field in the DCI points to a MAC CE codepoint referencing a pair of TCI states, such as uplink TCI state #1 and downlink TCI state #54, the UE may prepare for uplink transmission of, for example, a SRS, a PUCCH, or a PUSCH by using a beam corresponding to the uplink TCI state, and prepare for downlink reception of, for example, a CSI-RS, a PDCCH, or a PDSCH by using a beam corresponding to the downlink TCI state. Similarly, the uplink channel or reference signal to which each of the uplink TCI state and the downlink TCI state applies may be configured in advance, or may be determined according to a scope of the DCI.

It should be noted here that, in addition to the assumption of QCL-typeD, the downlink TCI state may include an assumption of QCL-TypeA with respect to the doppler shift and the delay spread, and the uplink TCI state generally includes only an assumption of QCL-TypeD. When a joint TCI state contains two QCL assumptions, namely, an assumption of QCL-TypeA and an assumption of QCL-TypeD, and is indicated to the UE, then for uplink of the UE, the UE refers to only the QCL-TypeD assumption, and can ignore the QCL-TypeA assumption.

According to the first embodiment of the present disclosure, unified configuration, activation, and dynamic indication can be performed for various types of TCI states, which is advantageous for improving flexibility of the beam indication. In addition, according to the first embodiment of the present disclosure, even the uplink and downlink TCI states may be activated and indicated as a combination, so that the requirement of indicating different beams for uplink and downlink transmissions can be met, and the efficiency of the beam indication is further improved.

### Second Embodiment

In the first embodiment, the base station may configure a hybrid TCI state pool for the UE, while according to the second embodiment, the base station may configure two independent TCI state pools.

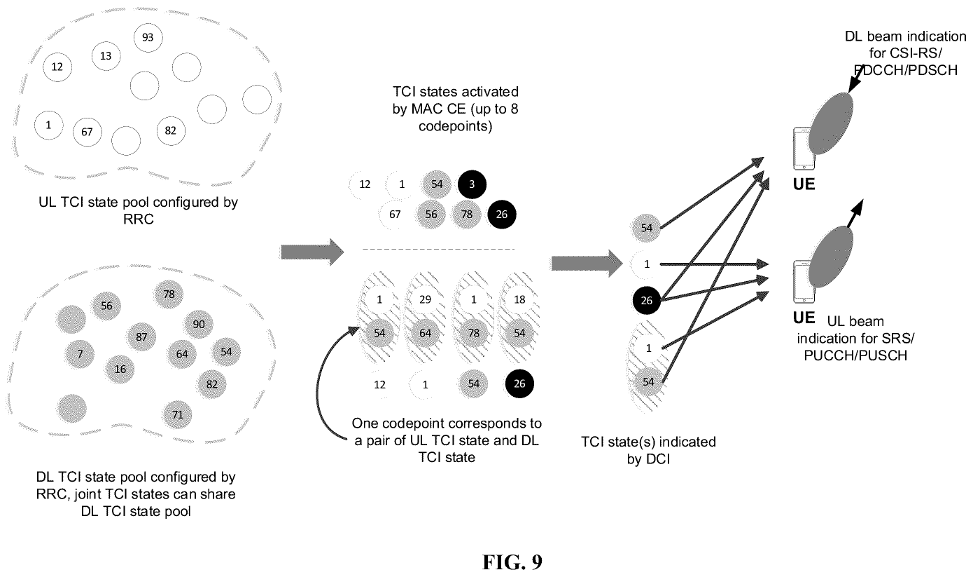

FIG. 9 illustrates a beam indication process according to the second embodiment of the present disclosure. As shown in FIG. 9, the base station configures, via RRC signaling, an uplink TCI state pool including only uplink TCI states (as indicated by hollow circles) and a downlink TCI state pool including only downlink TCI states (as indicated by light circles) for the UE.

It should be additionally noted that due to homogeneous characteristics of the joint TCI state and the downlink TCI state, the UE may reuse the downlink TCI state as the joint TCI state. In other words, in some instances, the downlink TCI state pool may be viewed as a TCI state pool in which downlink TCI states and joint TCI states are mixed.

For example, for a Frequency Division Duplex (FDD) system, the uplink TCI state pool may be configured on an uplink BWP and the downlink TCI state pool may be configured on a downlink BWP, so that the two TCI state pools are on different active BWPs. For a Time Division Duplex (TDD) system, since the uplink and downlink transmissions occupy the same active BWP, the uplink TCI state pool and the downlink TCI state pool can be configured on the same BWP.

All TCI states in the two configured TCI state pools are uniformly indexed such that the TCI states in the two TCI state pools have mutually different indices. From this perspective, the uplink TCI state pool and the downlink TCI state pool may be viewed as two proper subsets of a large TCI state pool. The benefit of such arrangement is that each TCI state ID is unique across both TCI state pools and does not cause unnecessary ambiguity.

Next, the MAC CE activation phase according to the second embodiment is substantially the same as the first embodiment, and the usable MAC CE format may be substantially the same as the MAC CE format shown in FIG. 7. Specifically, each codepoint of the MAC CE may reference a single TCI state, or may reference a pair of uplink and downlink TCI states.

Preferably, the MAC CE according to the second embodiment may further activate the downlink TCI state as the joint TCI state. For this case, the base station needs to inform the UE of usage of the TCI state, for example, whether it is a downlink TCI state or a joint TCI state. This may be achieved by modifying the MAC CE format shown in FIG. 7. For example, the “C_{N}” or “R” field preceding the TCI state ID field in the MAC CE may be redefined, and it indicates that the TCI state ID contained in the present octet presents a downlink TCI state if the “C_{N}” or “R” field takes a certain value (e.g., ‘1’), otherwise a joint TCI state. Alternatively, the MAC CE may add a flag field to indicate whether the corresponding TCI state is a downlink TCI state or a joint TCI state.

Finally, the DCI indication phase according to the second embodiment is the same as that in the first embodiment, and is not described herein again.

### Third Embodiment

According to the third embodiment of the present disclosure, the base station may configure more standby TCI state pools for the UE, and activate a TCI state in a certain TCI state pool in a manner of cascading two MAC CEs.

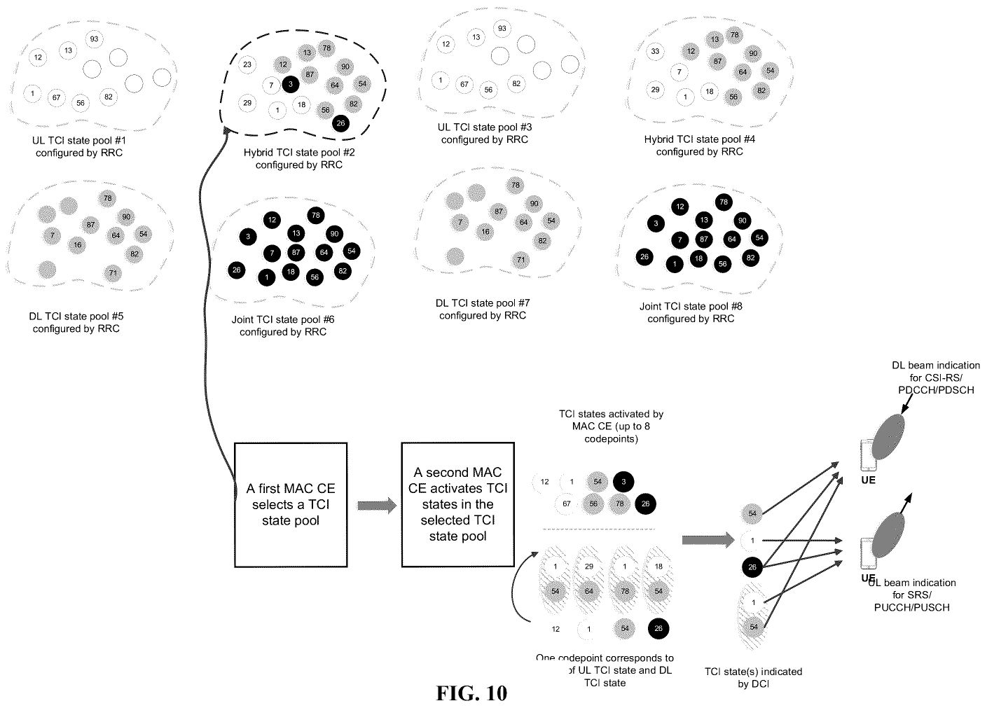

FIG. 10 shows a beam indication process according to the third embodiment. As shown in FIG. 10, the base station may configure 8 TCI state pools for the UE in advance, where TCI state pools #1 and #3 include only uplink TCI states, TCI state pools #2 and #4 include multiple types of TCI states, TCI state pools #5 and #7 include only downlink TCI states, and TCI state pools #6 and #8 include only joint TCI states. It should be understood that the number, size, type or the like of the TCI state pools configured in FIG. 10 are merely examples, and in practice, the base station may perform the configuration as needed.

Unlike the second embodiment, the TCI state pools according to the third embodiment do not require uniform indexing of the TCI states. That is, there may be overlapping TCI states between two TCI state pools. In this instance, direct referencing to TCI state IDs by a MAC CE may cause ambiguity. Thus, according to the third embodiment, the base station may implement activation of the TCI states with two MAC CEs, that is, the MAC CE activation phase includes activation/selection of TCI state pool(s) and activation of specific TCI states.

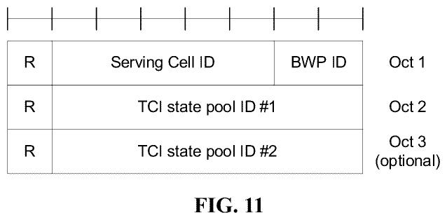

Specifically, the base station first selects one or more TCI state pools (e.g., TCI state pool #2 shown in FIG. 10) from the configured TCI state pools using a first MAC CE. FIG. 11 shows an example of a MAC CE format for selecting a TCI state pool. As shown in FIG. 11, such a MAC CE may include “Serving Cell ID”, “BWP ID” fields to indicate the serving cell and BWP to which the MAC CE is applicable; and may include a “TCI state pool ID” field to indicate a TCI state pool to select.

As shown in FIG. 11, the MAC CE may also select two TCI state pools by means of the fields “TCI state pool ID #1” and “TCI state pool ID #2”, for example, when different TCI state pools are used in the uplink and downlink. It is contemplated that the MAC CE may include more “TCI state pool ID” fields to select more TCI state pools. The “TCI state pool ID” field of the MAC CE in FIG. 11 occupies 7 bits to support at most 128 configured TCI state pools, but the number of actually configured TCI state pools is much less than 128, such as 4, 8, 16, 32 or the like, and then the “TCI state pool ID” field may correspondingly occupy 2 bits, 3 bits, 4 bits, 5 bits, or the like.

Returning to FIG. 10, after selecting the TCI state pool, the base station may use a second MAC CE to activate one or more TCI states in the selected TCI state pool. The format of the MAC CE used herein may be the same as the MAC CE according to the first embodiment or the second embodiment.

Finally, the base station may indicate one of the activated TCI states to the UE using a DCI. The DCI indication phase according to the third embodiment is the same as that in the first embodiment, and is not described herein again.

### Fourth Embodiment

In the foregoing first to third embodiments, the case of a single transmit and receive point (TRP) was discussed. The fourth embodiment of the present disclosure will consider a beam indication for multiple TRPs.

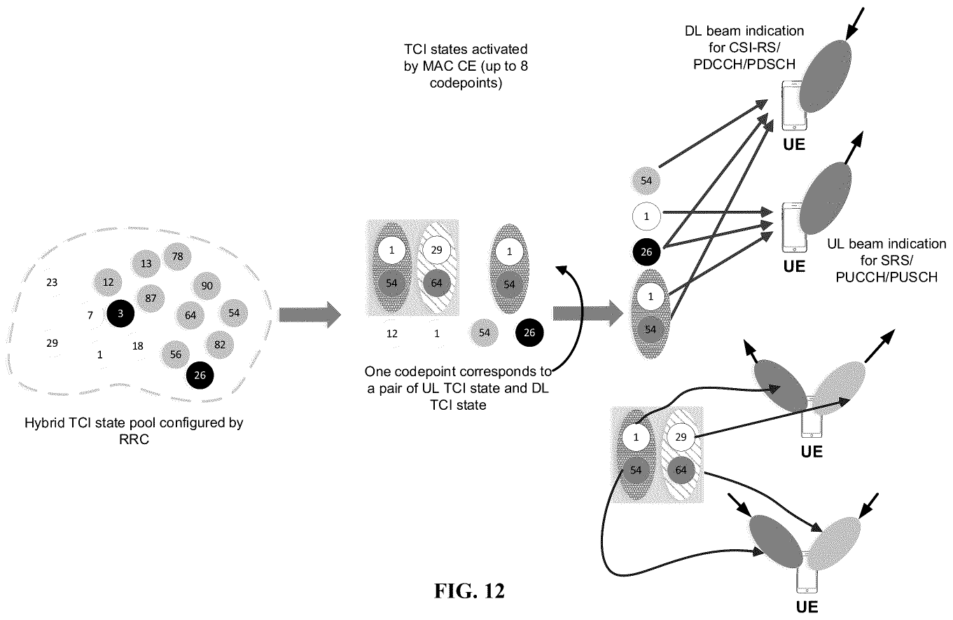

FIG. 12 shows a beam indication process according to the fourth embodiment, where the base station will dynamically indicate beams used by the UE for communicating with two TRPs to the UE. It is to be understood that the number of TRPs may not be limited to two, but may be any plurality as necessary, with no essential difference in the solution.

The RRC configuration phase of the beam indication procedure according to the fourth embodiment is the same as that of the first embodiment, and is not described again here.

As shown in FIG. 12, in the MAC CE activation stage, the MAC CE may activate TCI states for each TRP, respectively. Depending on different activation requirements, there are different cases of referencing to TCI states by the codepoints of the MAC CE:
1) if only the uplink beam or the downlink beam of a certain TRP needs to be indicated, the codepoint may refer to a single TCI state, such as an uplink TCI state corresponding to the uplink transmission beam to be indicated (e.g., TCI state #12, #1), a downlink TCI state corresponding to the downlink reception beam to be indicated (e.g., TCI state #54), a joint TCI state corresponding to symmetric uplink and downlink beams (e.g., TCI state #26);
2) if different uplink and downlink beams need to be set for only a certain TRP, the codepoint may refer to a pair of uplink TCI state and downlink TCI state, for example, uplink TCI state #1 and downlink TCI state #54;
3) if different uplink and downlink beams need to be set for both TRPs, the codepoint may refer to two pairs of uplink TCI states and downlink TCI states, for example, uplink TCI state #1 and downlink TCI state #54 for the first TRP, and uplink TCI state #29 and downlink TCI state #64 for the second TRP;
4) although not shown in FIG. 12, it is also conceivable to have the codepoint reference a single TCI state for a certain TRP (e.g., an uplink TCI state, a downlink TCI state, or a joint TCI state), and a pair of TCI states for the other TRP, thereby providing different beam indication effects for the two TRPs.

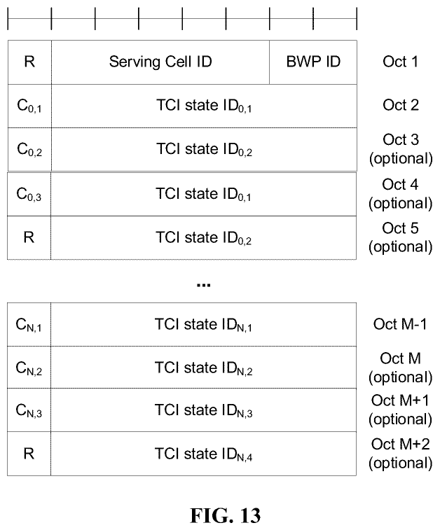

To achieve TCI state activation for multiple TRPs, the existing MAC CE format needs to be modified. FIG. 13 shows an example format of a MAC CE according to the fourth embodiment. An exemplary MAC CE may include a “Serving Cell ID” and a “BWP ID” field to indicate the serving cell and BWP to which the MAC CE is applicable. In addition, the MAC CE may include a plurality of “TCI state ID” fields to indicate TCI states to be activated.

In the MAC CE shown in FIG. 13, each of the codepoints may reference at most 4 TCI states, corresponding to the uplink and the downlink for 2 TRPs, however it is understood that the maximum number of TCI states that can be referenced by each codepoint may increase as the TRPs increase. For the N-th codepoint, the field “C_{N,i}” represents whether a TCI state exists in the next octet, if ‘1’, it represents existence, otherwise it represents nonexistence.

Preferably, the TCI states referenced by each codepoint may be in some predetermined order to facilitate identification by the UE, for example, a downlink TCI state or joint TCI state for the first TRP, an uplink TCI state for the first TRP, a downlink TCI state or joint TCI state for the second TRP, an uplink TCI state of the second TRP, and so on. Of course, the TCI states in each codepoint may be in an alternative order or no order, as long as it guarantees that the UE can align the TCI states with the TRPs.

Returning to FIG. 12, in the DCI indication phase, the base station may point to one codepoint of the MAC CE via a DCI, thereby indicating to the UE the TCI state to be enabled, and various possible cases are shown as follows:
1) if the codepoint references a downlink TCI state for the first TRP, such as TCI state #54, for example, the UE prepares to receive a CSI-RS, a PDSCH, a PDCCH or the like from the first TRP using a downlink reception beam corresponding to the TCI state;
2) if the codepoint references an uplink TCI state for the first TRP, such as TCI state #1, for example, the UE prepares to transmit a SRS, a PUSCH, a PUCCH or the like to the first TRP using an uplink transmission beam corresponding to the TCI state;
3) if the codepoint references a joint TCI state for the first TRP, such as TCI state #26, for example, the UE prepares to receive a CSI-RS, a PDSCH, a PDCCH or the like from the first TRP using a downlink reception beam corresponding to the TCI state, and prepares to transmit a SRS, a PUSCH, a PUCCH or the like to the first TRP using an uplink transmission beam corresponding to the TCI state;
4) if the codepoint references a pair of TCI states for the first TRP, such as uplink TCI state #1 and downlink TCI state #54, for example, the UE prepares to transmit a SRS, a PUSCH, a PUCCH or the like to the first TRP using an uplink transmission beam corresponding to the uplink TCI state, and prepares to receive a CSI-RS, a PDSCH, a PDCCH or the like from the first TRP using a downlink reception beam corresponding to the downlink TCI state;
5) if the codepoint references pairs of TCI states for two TRPs, such as uplink TCI state #1 and downlink TCI state #54 for the first TRP, and uplink TCI state #29 and downlink TCI state #64 for the second TRP, then for the first TRP, the UE prepares for uplink transmission to and downlink reception from the first TRP using beams corresponding to the TCI state #1 and the TCI state #54, respectively, and for the second TRP, the UE prepares for uplink transmission to and downlink reception from the second TRP using beams corresponding to TCI state #29 and the TCI state #64, respectively.

By means of the fourth embodiment of the present disclosure, flexible beam indication can be simultaneously implemented for a plurality of TRPs, which is helpful to improve the efficiency of beam indication.

### Fifth Embodiment

The scenarios in which the communication network configures the UE with TCI states in one serving cell have been discussed in the foregoing first to fourth embodiments. The fifth embodiment of the present disclosure will consider a scenario of multiple cells.

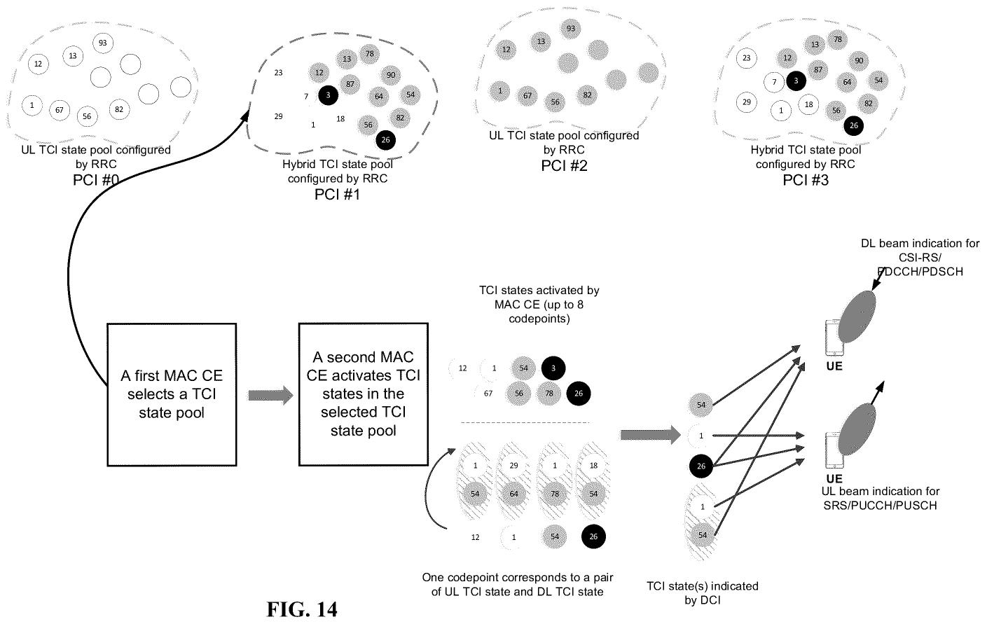

FIG. 14 shows a beam indication process according to the fifth embodiment. The communication network may configure the UE with TCI states in multiple serving and non-serving cells, and the TCI states of how many cells that may be configured to the UE depend on the capability of the UE. The UE may report its capability to the communication network after cell access.

As shown in FIG. 14, each cell is identified by a corresponding physical cell ID (PCI), and the base station (e.g., a primary cell) may configure the UE with TCI state pools for multiple cells, including an uplink TCI state pool for Cell #0, a hybrid TCI state pool for Cell #1, a downlink TCI state pool for Cell #2, and a hybrid TCI state pool for Cell #3. It should be understood, however, that FIG. 14 is merely exemplary, the number of cells may not be limited to 4, the TCI state pool for each cell may include one or more TCI states, and in connection with the foregoing second embodiment, each of the cells may have more than one TCI state pool.

According to the fifth embodiment, the base station may implement the activation of TCI states with two cascading MAC CEs, that is, the MAC CE activation phase includes selection of a cell and activation of specific TCI states.

Specifically, as shown in FIG. 14, the base station first uses a first MAC CE to select a corresponding cell (e.g., PCI #1 shown in FIG. 14) from a plurality of cells, that is, this cell then is to perform beam management for the UE.

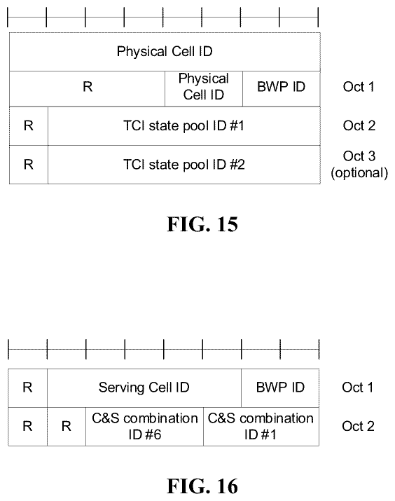

FIG. 15 shows an example format of a MAC CE for selecting a cell. As shown in the figure, such MAC CE may include “Physical Cell ID” and “BWP ID” fields to indicate the physical cell and BWP to which the MAC CE is applicable, where the physical cell ID (PCI) requires 10 bits to be carried. The MAC CE may also include a “TCI state pool ID” field to indicate the TCI state pool to select. This is particularly useful where multiple TCI state pools (e.g., separate uplink and downlink TCI state pools) are assigned for a cell.

Returning to FIG. 14, after selecting a cell and its TCI state pool, the base station may activate one or more TCI states in the selected TCI state pool using a second MAC CE. The format of the MAC CE used here may be the same as the MAC CE according to the first embodiment or the second embodiment.

Finally, the base station may indicate one of the activated TCI states to the UE using a DCI so that the UE can quickly perform communication with a certain serving or non-serving cell, or cell handover. The DCI indication phase according to the fifth embodiment is the same as that in the first embodiment, and is not described herein again.

### Sixth Embodiment

After actual deployment of a NR communication system, it is found that in many cases, the same beam pair can often be used in various channels and reference signals for communication between the base station and the UE, that is, so-called common beam operation is employed, without independent beam management of individual channel or reference signal. From this point of view, there is an opportunity to further reduce the overhead of signaling for the beam management.

The direction currently seen is that when common beam operation is required for two channels or reference signals, the base station configures, via RRC, use of a common TCI state for the beam indication. However, there is a problem that a time delay of the RRC signaling is significant and the common beam operation between the channel and the reference signal cannot be changed quickly.

The sixth embodiment of the present disclosure will discuss implementing a flexible common beam operation between two or more channels or reference signals on the basis of the foregoing first to fifth embodiments.

According to the sixth embodiment of the present disclosure, several combinations of channels or reference signals to which the common beam operation is applicable may be predefined and configured to the UE at one time via RRC signaling by the base station.

The following table illustrates several combinations of channels or reference signals that can share beams, however it should be understood that these combinations are merely illustrative and that more or fewer combinations may be defined by the base station depending on actual needs.

| Combination | | |
|---|---|---|
| No. | Channel or Reference Signal | TCI State |
| 1 | PDCCH and PDSCH scheduled by it | Downlink TCI state |
| 2 | PDCCH and aperiodic CSI-RS | Downlink TCI state |
| | triggered by it | |
| 3 | PDCCH, PDSCH, CSI-RS | Downlink TCI state |
| 4 | PDSCH, CSI-RS | Downlink TCI state |
| 5 | PUSCH and its HARQ feedback | Uplink TCI state |
| | (PUCCH) | |
| 6 | PUSCH and SRS in the same slot | Uplink TCI state |
| 7 | PUSCH, PUCCH, SRS | Uplink TCI state |
| 8 | PDCCH and PUSCH scheduled by it | Joint TCI state |
| 9 | PDCCH and aperiodic SRS | Joint TCI state |
| | triggered by it | |
| 10 | PDCCH, PDSCH, PUCCH, PUSCH | Joint TCI state |

When the common beam operation on a certain combination is required, the base station may enable the combination via a MAC CE according to the sixth embodiment of the present disclosure.

In one example, the MAC CE may enable a preconfigured combination of channels or reference signals in the form of bitmap, with each bit in the bitmap corresponding to a respective combination. In connection with the above table example, the MAC CE may give a 10-bit message, for example, “1000100010”, which indicates that a PDCCH and a PDSCH scheduled thereby share a beam, a PUSCH and a PUCCH providing a HARQ feedback share a beam, and a PDCCH and an aperiodic SRS triggered thereby share beams (a downlink reception beam and its symmetric uplink transmission beam). It should be understood that the number of bits of the bitmap is not limited to 10, but may depend on the number of configured combinations, that is, should be greater than or equal to the number of combinations.

Subsequently, by means of the beam indication process described in the first to fifth embodiments of the present disclosure, the base station may indicate a corresponding TCI state for the channels or reference signals in the activated combination. For example, in the above example, for a PDCCH and a PDSCH sharing a beam, the base station may indicate a downlink TCI state corresponding to the beam to the UE, and the UE uses the beam indicated by the TCI state to prepare for downlink reception of the PDCCH and the PDSCH based on the TCI state and the enabling information for the combination. Similarly, for a PUSCH and a PUCCH, or a PDCCH and SRS that share a beam or beams, a corresponding uplink TCI state and joint TCI state may be used for the beam indication, respectively.

In another example, the MAC CE may also directly specify an index of the combination of channels or reference signals to be enabled. FIG. 16 illustrates a format example of such a MAC CE. As illustrated, the MAC CE may include “Physical Cell ID” and “BWP ID” fields representing the physical cell and BWP to which the MAC CE is applicable, where the Physical Cell ID (PCI) requires 10 bits to be carried. The MAC CE may also include a “CIS combination ID” field to indicate a combination of channels or reference signals that employs the common beam operation. Although FIG. 16 illustrates enabling Combinations #6 and #1, it is to be understood that this is merely illustrative, and that a MAC CE may enable only one combination or may enable more combinations by including more “&S combination ID” fields.

Subsequently, by means of the beam indication process described in the first to fifth embodiments of the present disclosure, the base station may indicate a corresponding TCI state for the channels or reference signals in the enabled combination, and the UE uses the beam indicated by the TCI state for all channels or reference signals in the combination based on the TCI state and the enabling information for the combination.

There are other possible MAC CE formats as long as the UE can be informed of the combination of channels or reference signals that employs the common beam operation. In addition, it should be understood that the bitmap or the combination index described above may be included in a newly defined MAC CE, or may be included in the MAC CE for activating TCI states or TCI state pool as described above.

[Electronic Device and Communication Method]

Electronic devices and communication methods in which various embodiments of the present disclosure can be implemented are described below in connection with figures.

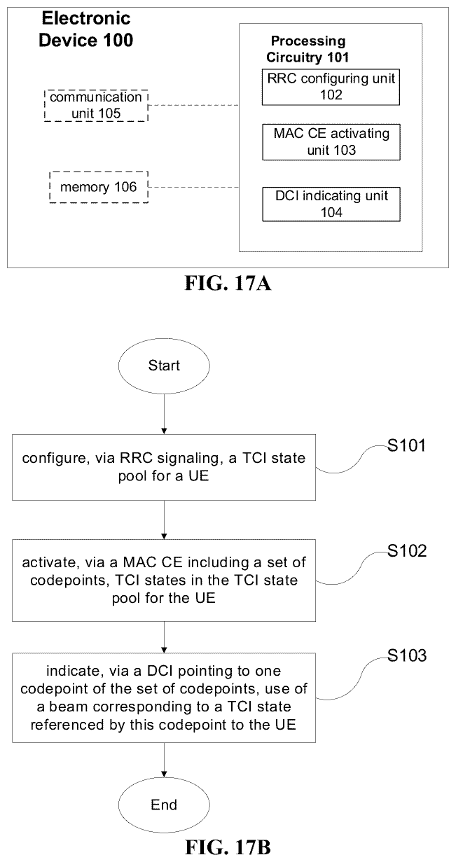

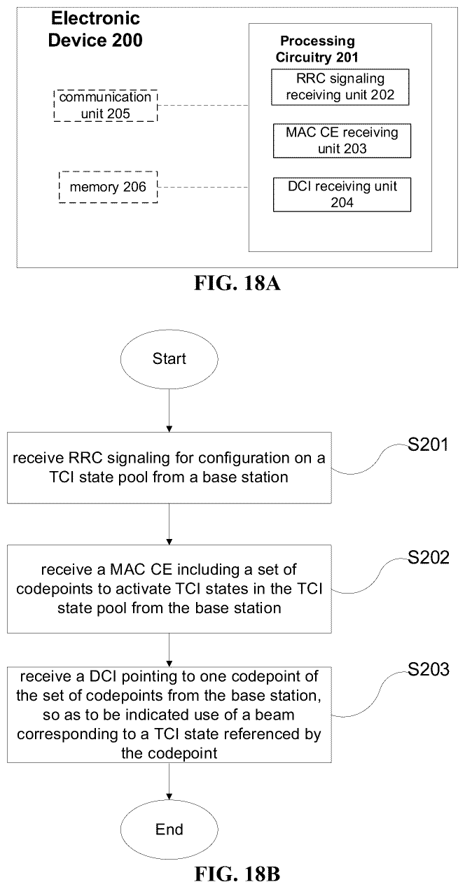

FIG. 17A is a block diagram illustrating an electronic device 100 on the base station side according to the embodiments of the present disclosure, and FIG. 17B illustrates a flowchart of a communication method that can be performed by the electronic device 100. The electronic device 100 may be a base station or a component thereof.

As shown in FIG. 17A, the electronic device 100 comprises processing circuitry 101. The processing circuitry 101 includes at least a RRC configuring unit 102, a MAC CE activating unit 103, and a DCI indicating unit 104. The processing circuitry 101 may be configured to perform the communication method as shown in FIG. 17B. The processing circuitry 101 may refer to various implementations of digital, analog, or mixed-signal (a combination of analog signal and digital signal) circuitry for performing functions in a computing system. The processing circuitry may include, for example, circuitry such as an integrated circuit (IC) or an application specific integrated circuit (ASIC), portions or circuits of an individual processor core, an entire processor core, an individual processor, a programmable hardware device such as a field programmable gate array (FPGA), and/or a system including multiple processors.

The RRC configuring unit 102 in the processing circuitry 101 is configured to configure, via RRC signaling, a TCI state pool for a UE, that is, to perform step S101 in FIG. 17B. The configured TCI state pool may be a single hybrid TCI state pool including at least two of joint TCI states, uplink TCI states, downlink TCI states, or may be two or more separate TCI state pools. In addition, the RRC configuring unit 102 may also configure a plurality of TCI state pools corresponding to a plurality of cells for the UE.

The MAC CE activating unit 103 is configured to activate, via a MAC CE including a set of codepoints, TCI states in the TCI state pool for the UE, that is, to perform step S102 in FIG. 17B. Each of the codepoints in the MAC CE is capable to reference any of: a) a single downlink TCI state; b) a single uplink TCI state; c) a single joint TCI state; and d) a pair of uplink TCI state and downlink TCI state.

In one example, the MAC CE activating unit 103 may select, via a first MAC CE, one or more TCI state pools from a plurality of TCI state pools, and then activate, via a second MAC CE, TCI states in the selected TCI state pools. In another example, the MAC CE activating unit 103 may activate a single TCI state or a pair of TCI states for each of a plurality of TRPs.

The DCI indicating unit 104 is configured to indicate, via a DCI pointing to one codepoint of the set of codepoints, use of a beam corresponding to a TCI state referenced by this codepoint to the UE, that is, to perform step S103 in FIG. 17B.

In addition, the processing circuitry 101 may further comprise means configured to indicate, via a MAC CE, which one or more of a plurality of predefined combinations of channels or reference signals share a beam or beams to the UE.

The electronic device 100 may further comprise a communication unit 105 and a memory 106, for example.

The communication unit 105 can be configured to communicate with a user equipment (e.g., an electronic device 200 to be described below) under control of the processing circuitry 101. In one example, the communication unit 105 can be implemented as a transmitter or transceiver including communication components such as an antenna array and/or a radio frequency link. The communication unit 105 is depicted with a dashed line since it may also be located outside the electronic device 100.

The electronic device 100 may also include a memory 106. The memory 106 may store various data and instructions, such as programs and data for operation of the electronic device 100, various data generated by the processing circuitry 101, data to be received by the communication unit 105 and the like. The memory 106 may be a volatile memory and/or a non-volatile memory. For example, the memory 106 may include, but is not limited to, Random Access Memory (RAM), Dynamic Random Access Memory (DRAM), Static Random Access Memory (SRAM), Read Only Memory (ROM), or flash memory.

FIG. 18A is a block diagram illustrating an electronic device 200 according to the present disclosure. The electronic device 200 may be a user equipment or a component thereof.

As shown in FIG. 18A, the electronic device 200 comprises processing circuitry 201. The processing circuitry 201 includes at least a RRC signaling receiving unit 202, a MAC CE receiving unit 203 and a DCI receiving unit 204. The processing circuitry 201 may be configured to perform a communication method as shown in FIG. 18B. The processing circuitry 201 may refer to various implementations of digital, analog, or mixed-signal (a combination of analog signal and digital signal) circuitry for performing functions in a computing system. The processing circuitry may include, for example, circuitry such as an integrated circuit (IC) or an application specific integrated circuit (ASIC), portions or circuits of an individual processor core, an entire processor core, an individual processor, a programmable hardware device such as a field programmable gate array (FPGA), and/or a system including multiple processors.

The RRC signaling receiving unit 202 of the processing circuitry 201 is configured to receive RRC signaling for configuration of a TCI state pool from the base station, that is, to perform step S201 in FIG. 18B. The configured TCI state pool may be a single hybrid TCI state pool, or may be two or more separate TCI state pools. In addition, the RRC signaling may further configure a plurality of TCI state pools corresponding to a plurality of cells for the UE.

The MAC CE receiving unit 203 is configured to receive a MAC CE including a set of codepoints to activate TCI states in the TCI state pool from the base station, that is, to perform step S202 in FIG. 18B. Each of the codepoints of the MAC CE is capable of referencing any of: a) a single downlink TCI state; b) a single uplink TCI state; c) a single joint TCI state; and d) a pair of uplink TCI state and downlink TCI state.

The MAC CE received by the MAC CE receiving unit 203 may include a first MAC CE that selects one or more TCI state pools from the plurality of TCI state pools, and a second MAC CE that activates TCI states from the selected TCI state pools. Further, the MAC CE may activate a single TCI state or a pair of TCI states for each of a plurality of TRPs.

The DCI receiving unit 204 is configured to receive a DCI pointing to one codepoint of the set of codepoints from the base station, so as to be indicated use of a beam corresponding to a TCI state referenced by the codepoint, that is, to perform step S203 in FIG. 18B.

In addition, the processing circuitry 201 may further include means configured to receive a MAC CE indicating which one or more of a plurality of predefined combinations of channels or reference signals will share a beam or beams to the UE.

The electronic device 200 may also include a memory 205 and a memory 206.

The communication unit 205 can be configured to communicate with a base station device (e.g., the electronic device 100 as described above) under control of the processing circuitry 201. In one example, the communication unit 205 can be implemented as a transmitter or transceiver including communication components such as an antenna array and/or a radio frequency link. The communication unit 205 is depicted with a dashed line since it may also be located outside the electronic device 200.

The electronic device 200 may also include a memory 206. The memory 206 may store various data and instructions, such as programs and data for operation of the electronic device 200, various data generated by the processing circuitry 201, various control signaling or traffic data to be transmitted by the communication unit 205, and so forth. The memory 206 is depicted with a dashed line because it may also be located within the processing circuitry 201 or outside the electronic device 200. The memory 206 may be a volatile memory and/or a non-volatile memory. For example, the memory 206 may include, but is not limited to, Random Access Memory (RAM), Dynamic Random Access Memory (DRAM), Static Random Access Memory (SRAM), Read Only Memory (ROM), or flash memory.

It should be understood that the units of the electronic devices 100 and 200 described in the above embodiments are only logical modules divided according to the specific functions they implement, and are not used to limit specific implementations. In an actual implementation, the foregoing units may be implemented as individual physical entities, or may also be implemented by a single entity (for example, a processor (CPU or DSP, etc.), an integrated circuit, etc.).

Various aspects of the embodiments of the present disclosure have been described in detail above, but it will be appreciated that the structure, arrangement, type, number and the like of antenna arrays, ports, reference signals, communication devices, communication methods and the like are illustrated for purpose of description, and are not intended to limit the aspects of the present disclosure to these specific examples.

It should be understood that the units of the electronic devices 100 and 200 described in the above embodiments are only logical modules divided according to the specific functions they implement, and are not used to limit specific implementations. In an actual implementation, the foregoing units may be implemented as individual physical entities, or may also be implemented by a single entity (for example, a processor (CPU or DSP, etc.), an integrated circuit, etc.).

### Exemplary Implementations of the Present Disclosure

According to the embodiments of the present disclosure, various implementations for practicing concepts of the present disclosure can be conceived, including but not limited to:

1). An electronic device for a base station, comprising:
processing circuitry configured to
   configure, via RRC signaling, a transmission configuration indication (TCI) state pool for a user equipment (UE);
   activate, via MAC CE including a set of codepoints, TCI states in the TCI state pool for the UE, wherein each of the codepoints is capable of referencing any of
      a) a single downlink TCI state for indicating a downlink beam;
      b) a single uplink TCI state for indicating an uplink beam;
      c) a single joint TCI state for indicating a downlink beam and an uplink beam; or
      d) a pair of uplink TCI state and downlink TCI state; and
indicate, via a DCI pointing to one codepoint of the set of codepoints, use of a beam corresponding to a TCI state referenced by this codepoint to the UE.

2). The electronic device of 1), wherein the processing circuitry is further configured to configure, via the RRC signaling, whether each of the TCI states in the TCI state pool is a downlink TCI state, an uplink TCI state, or a joint TCI state.

3). The electronic device of 1), wherein the TCI state pool comprises a plurality of TCI state pools.

4). The electronic device of 3), wherein the plurality of TCI state pools comprise:
a first TCI state pool including uplink TCI states, and
a second TCI state pool including downlink TCI states,
wherein the TCI states in the first TCI state pool and in the second TCI state pool have different identification information from each other.

5). The electronic device of 4), wherein the processing circuitry is further configured to
reuse, via the MAC CE, one or more downlink TCI states in the second TCI state pool as joint TCI states.

6). The electronic device of 3), wherein the processing circuitry is further configured to
select, via a further MAC CE, a particular TCI state pool from the plurality of TCI state pools, and
wherein said MAC CE is used to activate TCI states in the particular TCI state pool.

7). The electronic device of 3), wherein the plurality of TCI state pools correspond to a plurality of cells.

8). The electronic device of 1), wherein each codepoint of the set of codepoints is capable to reference a single TCI state or a pair of uplink TCI state and downlink TCI state for each of a plurality of transmit and receive points (TRPs).

9). The electronic device of 1), wherein the processing circuitry is further configured to
send a further MAC CE to the UE, wherein the further MAC CE indicates which of a plurality of predefined combinations of channels or reference signals will share a common beam.

10). An electronic device for a user equipment (UE), comprising:
processing circuitry configured to
   receive RRC signaling for configuration on a transmission configuration indication (TCI) state pool from a base station;
   receive a MAC CE including a set of codepoints to activate TCI states in the TCI state pool from the base station, wherein each of the codepoints is capable to reference any of
      a) a single downlink TCI state for indicating a downlink beam;
      b) a single uplink TCI state for indicating an uplink beam;
      c) a single joint TCI state for indicating a downlink beam and an uplink beam; or
      d) a pair of uplink TCI state and downlink TCI state; and
receive a DCI pointing to one codepoint of the set of codepoints from the base station, so as to be indicated use of a beam corresponding to a TCI state referenced by the codepoint.

11). The electronic device of 10), wherein the RRC signaling further configures whether each of TCI states in the TCI state pool is a downlink TCI state, an uplink TCI state, or a joint TCI state.

12). The electronic device of 10), wherein the TCI state pool comprises a plurality of TCI state pools.

13). The electronic device of 12), wherein the plurality of pools of TCI states comprise:
a first TCI state pool including uplink TCI states; and
a second TCI state pool including downlink TCI state,
wherein identification information of the TCI states in the first TCI state pool and in the second TCI state pool are different from each other.

14). The electronic device of 12), the MAC CE reuses one or more downlink TCI states in the second TCI state pool as joint TCI states.

15). The electronic device of 12), the processing circuitry is further configured to:
receive a further MAC CE from the base station to select a particular TCI state pool from the plurality of TCI state pools,
wherein said MAC CE is used to activate TCI states in the particular TCI state pool.

16). The electronic device of 12), wherein the plurality of TCI state pools correspond to a plurality of cells, respectively.

17). The electronic device of 10), wherein each codepoint in the set of codepoints is capable of referencing a single TCI state or a pair of uplink and downlink TCI states for each of a plurality of transmit and receive points (TRPs).

18). The electronic device of 10), the processing circuitry is further configured to:
receive a further MAC CE from the base station, wherein the further MAC CE indicates which of a plurality of predefined combinations of channels or reference signals shares a common beam.

19). A communication method, comprising:
configuring, via RRC signaling, a transmission configuration indication (TCI) state pool for a user equipment (UE);
activating, via MAC CE including a set of codepoints, TCI states in the TCI state pool for the UE, wherein each of the codepoints is capable of referencing any of
   a) a single downlink TCI state for indicating a downlink beam;
   b) a single uplink TCI state for indicating an uplink beam;
   c) a single joint TCI state for indicating a downlink beam and an uplink beam; or
   d) a pair of uplink TCI state and downlink TCI state; and
indicating, via a DCI pointing to one codepoint of the set of codepoints, use of a beam corresponding to a TCI state referenced by this codepoint to the UE.

20). A communication method, comprising:
receiving RRC signaling for configuration on a transmission configuration indication (TCI) state pool from a base station;
receiving a MAC CE including a set of codepoints to activate TCI states in the TCI state pool from the base station, wherein each of the codepoints is capable to reference any of
   a) a single downlink TCI state for indicating a downlink beam;
   b) a single uplink TCI state for indicating an uplink beam;
   c) a single joint TCI state for indicating a downlink beam and an uplink beam; or
   d) a pair of uplink TCI state and downlink TCI state; and
receiving a DCI pointing to one codepoint of the set of codepoints from the base station, so as to be indicated use of a beam corresponding to a TCI state referenced by the codepoint.

21). A computer program product comprising executable instructions which, when executed, implement the communication method of any of claims 19) to 20).

### Application Examples of the Present Disclosure

The technology of the present disclosure can be applied to various products.

For example, the electronic device 100 according to the embodiments of the present disclosure can be implemented as a variety of base stations or included in a variety of base stations, and the electronic device 200 can be implemented as a variety of user devices or included in a variety of user devices.

The communication methods according to the embodiments of the present disclosure may be implemented by various base stations or user devices; the methods and operations according to the embodiments of the present disclosure may be embodied as computer-executable instructions, stored in a non-transitory computer-readable storage medium, and can be performed by various base stations or user devices to implement one or more of the above-mentioned functions.

The technology according to the embodiments of the present disclosure can be made into various computer program products, which can be used in various base stations or user devices to implement one or more of the above-mentioned functions.

It should be noted that the “base station” used in the present disclosure is not limited to the above two types of nodes, but encompasses various control devices on the network side, and has a full breadth of its usual meaning. The base stations mentioned in the present disclosure can be implemented as any type of base stations, preferably, such as the macro gNB or ng-eNB defined in the 3GPP 5G NR standard. A gNB may be a gNB that covers a cell smaller than a macro cell, such as a pico gNB, a micro gNB, and a home (femto) gNB. Instead, the base station may be implemented as any other types of base stations such as a NodeB, an eNodeB and a base transceiver station (BTS). The base station may include a main body configured to control wireless communication, and one or more remote radio heads (RRH), a wireless relay, a drone control tower, a control node in an automated factory or the like disposed in a different place from the main body.

Moreover, in the present disclosure, the term “UE” has a full breadth of its usual meaning, including various terminal devices communicating with the base station. The UE may be implemented as a mobile terminal such as a smartphone, a tablet personal computer (PC), a notebook PC, a portable game terminal, a portable/dongle type mobile router, and a digital camera apparatus, or an in-vehicle terminal such as a car navigation device. The terminal device may also be implemented as a terminal (that is also referred to as a machine type communication (MTC) terminal) that performs machine-to-machine (M2M) communication, a drone, a sensor or actuator in an automated factory or the like. Furthermore, the terminal device may be a wireless communication module (such as an integrated circuit module including a single die) mounted on each of the above terminals.

Examples of the base station and the UE in which the present disclosure can be applied will be described briefly below.

### First Application Example of Base Station

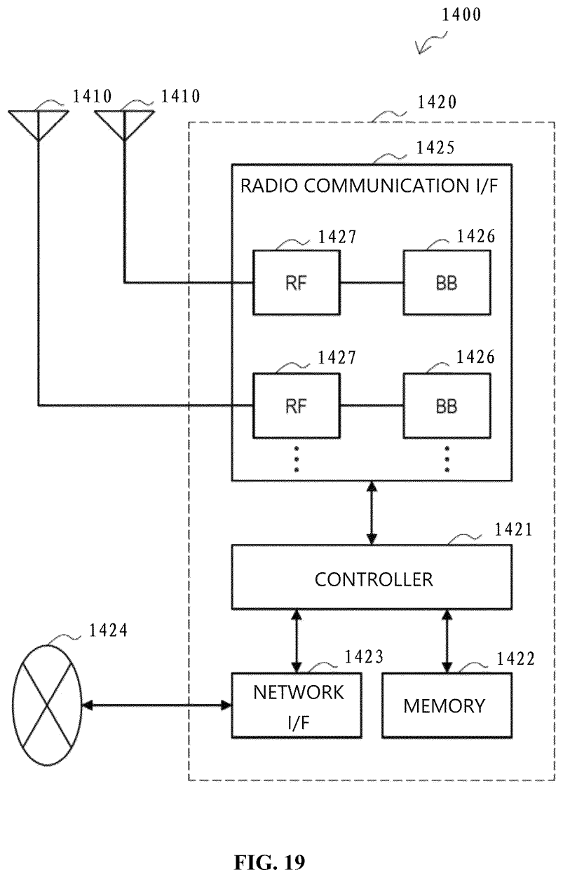

FIG. 19 is a block diagram showing a first example of a schematic configuration of a base station to which the technology of the present disclosure can be applied. In FIG. 19, the base station is implemented as gNB 1400. The gNB 1400 includes a plurality of antennas 1410 and a base station device 1420. The base station device 1420 and each antenna 1410 may be connected to each other via an RF cable. In an implementation manner, the gNB 1400 (or the base station device 1420) herein may correspond to any of the above-mentioned electronic device 100.

The antennas 1410 includes multiple antenna elements, such as multiple antenna arrays for large-scale MIMO. The antennas 1410, for example, can be arranged into a matrix of antenna arrays, and are used by the base station device 1420 to transmit and receive wireless signals. For example, multiple antennas 1410 may be compatible with multiple frequency bands used by gNB 1400.

The base station device 1420 includes a controller 1421, a memory 1422, a network interface 1423, and a radio communication interface 1425.

The controller 1421 may be, for example, a CPU or a DSP, and operates various functions of the base station device 1420 at a higher layer. For example, the controller 1421 may include any of the processing circuitry 101 as described above, perform the communication method described in FIG. 17B, or control various components of the electronic device 100. For example, the controller 1421 generates data packets based on data in signals processed by the radio communication interface 1425, and passes the generated packets via the network interface 1423. The controller 1421 may bundle data from multiple baseband processors to generate bundled packets, and pass the generated bundled packets. The controller 1421 may have logical functions that perform controls such as radio resource control, radio bearer control, mobility management, admission control, and scheduling. The controls can be performed in conjunction with a nearby gNB or core network node. The memory 1422 includes a RAM and a ROM, and stores a program executed by the controller 1421 and various types of control data such as a terminal list, transmission power data, and scheduling data.

The network interface 1423 is a communication interface for connecting the base station device 1420 to the core network 1424. The controller 1421 may communicate with a core network node or another gNB via the network interface 1423. In this case, the gNB 1400 and the core network node or other gNBs may be connected to each other through a logical interface such as an SI interface and an X2 interface. The network interface 1423 may also be a wired communication interface or a radio communication interface for a wireless backhaul line. If the network interface 1423 is a radio communication interface, compared with the frequency band used by the radio communication interface 1425, the network interface 1423 can use a higher frequency band for wireless communication.

The radio communication interface 1425 supports any cellular communication scheme such as 5G NR, and provides a wireless connection to a terminal located in a cell of the gNB 1400 via an antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and execute various types of signal processing in layers such as the physical layer, the MAC layer, the RLC layer, and the PDCP layer. As an alternative of the controller 1421, the BB processor 1426 may have a part or all of the above-mentioned logical functions. The BB processor 1426 may be a memory storing a communication control program, or a module including a processor and related circuits configured to execute the program. Updating the program can change the function of the BB processor 1426. The module may be a card or a blade inserted into a slot of the base station device 1420. Alternatively, the module may be a chip mounted on a card or a blade. Meanwhile, the RF circuit 1427 may include, for example, a mixer, a filter, and an amplifier, and transmits and receives a wireless signal via the antenna 1410. Although FIG. 19 illustrates an example in which one RF circuit 1427 is connected to one antenna 1410, the present disclosure is not limited to this illustration, but one RF circuit 1427 may be connected to multiple antennas 1410 at the same time.

As shown in FIG. 19, the radio communication interface 1425 may include a plurality of BB processors 1426. For example, the plurality of BB processors 1426 may be compatible with multiple frequency bands used by gNB 1400. As shown in FIG. 19, the radio communication interface 1425 may include a plurality of RF circuits 1427. For example, the plurality of RF circuits 1427 may be compatible with multiple antenna elements. Although FIG. 19 shows an example in which the radio communication interface 1425 includes a plurality of BB processors 1426 and a plurality of RF circuits 1427, the radio communication interface 1425 may also include a single BB processor 1426 or a single RF circuit 1427.

In the gNB 1400 illustrated in FIG. 19, one or more of the units included in the processing circuitry 101 described with reference to FIG. 17A may be implemented in the radio communication interface 1425. Alternatively, at least a part of these components may be implemented in the controller 1421. As an example, the gNB 1400 includes a part (for example, the BB processor 1426) or the entire of the radio communication interface 1425 and/or a module including the controller 1421, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 1400, and the radio communication interface 1425 (for example, the BB processor 1426) and/or the controller 1421 may execute the program. As described above, as a device including the one or more components, the gNB 1400, the base station device 1420 or the module may be provided. In addition, a readable medium in which the program is recorded may be provided.

### Second Application Example of Base Station

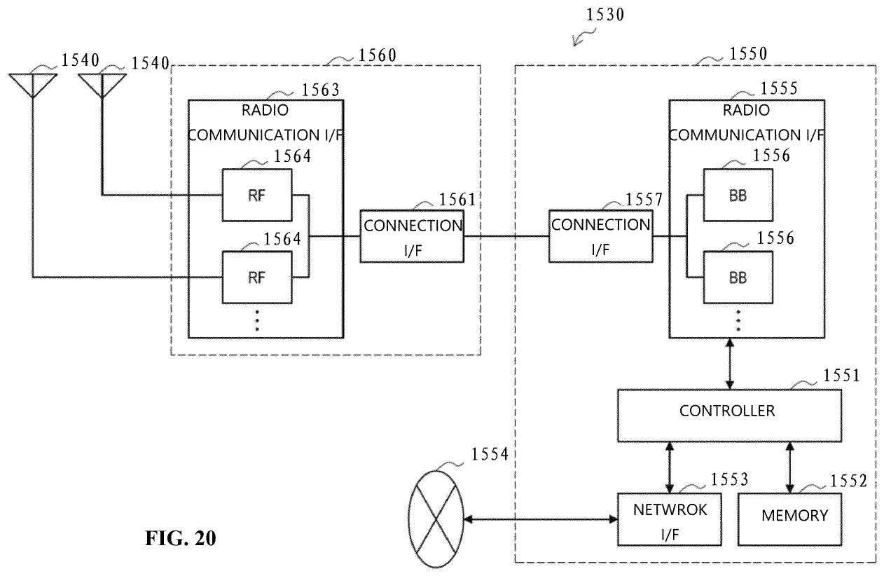

FIG. 20 is a block diagram showing a second example of a schematic configuration of a base station to which the technology of the present disclosure can be applied. In FIG. 20, the base station is shown as gNB 1530. The gNB 1530 includes multiple antennas 1540, base station equipment 1550, and RRH 1560. The RRH 1560 and each antenna 1540 may be connected to each other via an RF cable. The base station equipment 1550 and the RRH 1560 may be connected to each other via a high-speed line such as a fiber optic cable. In an implementation manner, the gNB 1530 (or the base station device 1550) herein may correspond to the above-mentioned electronic device 100.

The antennas 1540 includes multiple antenna elements, such as multiple antenna arrays for large-scale MIMO. The antennas 1540, for example, can be arranged into a matrix of antenna arrays, and are used by the base station device 1550 to transmit and receive wireless signals. For example, multiple antennas 1540 may be compatible with multiple frequency bands used by gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 19.

The radio communication interface 1555 supports any cellular communication scheme such as 5G NR, and provides wireless communication to a terminal located in a sector corresponding to the RRH 1560 via the RRH 1560 and the antenna 1540. The radio communication interface 1555 may typically include, for example, a BB processor 1556. The BB processor 1556 is the same as the BB processor 1426 described with reference to FIG. 19 except that the BB processor 1556 is connected to the RF circuit 1564 of the RRH 1560 via the connection interface 1557. As shown in FIG. 20, the radio communication interface 1555 may include a plurality of BB processors 1556. For example, multiple BB processors 1556 may be compatible with multiple frequency bands used by gNB 1530. Although FIG. 20 shows an example in which the radio communication interface 1555 includes a plurality of BB processors 1556, the radio communication interface 1555 may also include a single BB processor 1556.

The connection interface 1557 is an interface for connecting the base station device 1550 (radio communication interface 1555) to the RRH 1560. The connection interface 1557 may also be a communication module for communication in the above-mentioned high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module for communication in the above-mentioned high-speed line.

The radio communication interface 1563 transmits and receives wireless signals via the antenna 1540. The radio communication interface 1563 may generally include, for example, an RF circuit 1564. The RF circuit 1564 may include, for example, a mixer, a filter, and an amplifier, and transmits and receives wireless signals via the antenna 1540. Although FIG. 20 illustrates an example in which one RF circuit 1564 is connected to one antenna 1540, the present disclosure is not limited to this illustration, but one RF circuit 1564 may be connected to multiple antennas 1540 at the same time.

As shown in FIG. 20, the radio communication interface 1563 may include a plurality of RF circuits 1564. For example, the plurality of RF circuits 1564 may support multiple antenna elements. Although FIG. 20 shows an example in which the radio communication interface 1563 includes a plurality of RF circuits 1564, the radio communication interface 1563 may include a single RF circuit 1564.

In the gNB 1500 shown in FIG. 20, one or more units included in the processing circuitry 101 described with reference to FIG. 17A may be implemented in the radio communication interface 1525. Alternatively, at least a part of these components may be implemented in the controller 1521. For example, the gNB 1500 includes a part (for example, the BB processor 1526) or the whole of the radio communication interface 1525, and/or a module including the controller 1521, and one or more components may be implemented in the module. In this case, the module may store a program for allowing the processor to function as one or more components (in other words, a program for allowing the processor to perform operations of one or more components), and may execute the program. As another example, a program for allowing the processor to function as one or more components may be installed in the gNB 1500, and the radio communication interface 1525 (for example, the BB processor 1526) and/or the controller 1521 may execute the program. As described above, as a device including one or more components, the gNB 1500, the base station device 1520, or a module may be provided, and a program for allowing the processor to function as one or more components may be provided. In addition, a readable medium in which the program is recorded may be provided.

### First Application Example of User Equipment

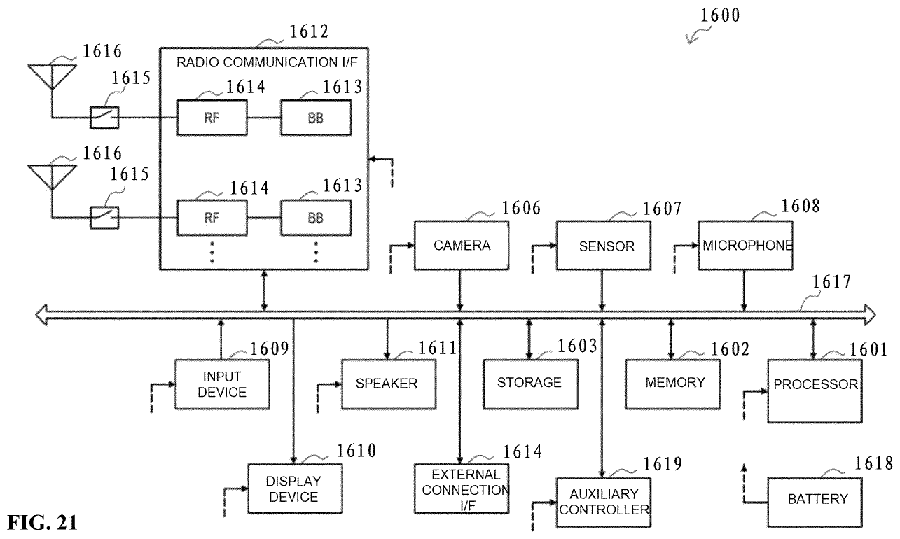

FIG. 21 is a block diagram showing an example of a schematic configuration of a smartphone 1600 to which the technology of the present disclosure can be applied. In an example, the smart phone 1600 may be implemented as the electronic device 200 described with reference to FIG. 18A.

The smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619.

The processor 1601 may be, for example, a CPU or a system on chip (SoC), and controls functions of an application layer and another layer of the smartphone 1600. The processor 1601 may include or serve as the processing circuitry 201 described with reference to FIG. 18A. The memory 1602 includes a RAM and a ROM, and stores data and programs executed by the processor 1601. The storage device 1603 may include a storage medium such as a semiconductor memory and a hard disk. The external connection interface 1604 is an interface for connecting external devices such as a memory card and a universal serial bus (USB) device to the smartphone 1600.

The camera device 1606 includes an image sensor such as a charge-coupled device (CCD) and a complementary metal oxide semiconductor (CMOS), and generates a captured image. The sensor 1607 may include a set of sensors such as a measurement sensor, a gyroscope sensor, a geomagnetic sensor, and an acceleration sensor. The microphone 1608 converts a sound input to the smartphone 1600 into an audio signal. The input device 1609 includes, for example, a touch sensor, a keypad, a keyboard, a button, or a switch configured to detect a touch on the screen of the display device 1610, and receives an operation or information input from a user. The display device 1610 includes a screen such as a liquid crystal display (LCD) and an organic light emitting diode (OLED) display, and displays an output image of the smartphone 1600. The speaker 1611 converts an audio signal output from the smartphone 1600 into a sound.

The radio communication interface 1612 supports any cellular communication scheme such as 4G LTE, 5G NR or the like, and performs wireless communication. The radio communication interface 1612 may generally include, for example, a BB processor 1613 and an RF circuit 1614. The BB processor 1613 may perform, for example, encoding/decoding, modulation/demodulation, and multiplexing/demultiplexing, and perform various types of signal processing for wireless communication. Meanwhile, the RF circuit 1614 may include, for example, a mixer, a filter, and an amplifier, and transmits and receives wireless signals via the antenna 1616. The radio communication interface 1612 may be a chip module on which a BB processor 1613 and an RF circuit 1614 are integrated. As shown in FIG. 21, the radio communication interface 1612 may include multiple BB processors 1613 and multiple RF circuits 1614. Although FIG. 21 illustrates an example in which the radio communication interface 1612 includes a plurality of BB processors 1613 and a plurality of RF circuits 1614, the radio communication interface 1612 may also include a single BB processor 1613 or a single RF circuit 1614.

In addition, in addition to the cellular communication scheme, the radio communication interface 1612 may support other types of wireless communication scheme, such as a short-range wireless communication scheme, a near field communication scheme, and a wireless local area network (LAN) scheme. In this case, the radio communication interface 1612 may include a BB processor 1613 and an RF circuit 1614 for each wireless communication scheme.

Each of the antenna switches 1615 switches a connection destination of the antenna 1616 between a plurality of circuits included in the radio communication interface 1612 (for example, circuits for different wireless communication schemes).

The antennas 1616 includes multiple antenna elements, such as multiple antenna arrays for large-scale MIMO. The antennas 1616, for example, can be arranged into a matrix of antenna arrays, and are used by the radio communication interface 1612 to transmit and receive wireless signals. The smart phone 1600 can includes one or more antenna panels (not shown).

In addition, the smartphone 1600 may include an antenna 1616 for each wireless communication scheme. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619 to each other. The battery 1618 supplies power to each block of the smartphone 1600 shown in FIG. 21 via a feeder, and the feeder is partially shown as a dotted line in the figure. The auxiliary controller 1619 operates the minimum necessary functions of the smartphone 1600 in the sleep mode, for example.

In the smart phone 1600 shown in FIG. 21, one or more units included in the processing circuitry 201 described with reference to FIG. 18A may be implemented in the radio communication interface 1612. Alternatively, at least a part of these components may be implemented in the processor 1601 or the auxiliary controller 1619. As an example, the smart phone 1600 includes a part (for example, the BB processor 1613) or the whole of the radio communication interface 1612, and/or a module including the processor 1601 and/or the auxiliary controller 1619, and one or more components may be Implemented in this module. In this case, the module may store a program that allows processing to function as one or more components (in other words, a program for allowing the processor to perform operations of one or more components), and may execute the program. As another example, a program for allowing the processor to function as one or more components may be installed in the smart phone 1600, and the radio communication interface 1612 (for example, the BB processor 1613), the processor 1601, and/or the auxiliary The controller 1619 can execute this program. As described above, as a device including one or more components, a smart phone 1600 or a module may be provided, and a program for allowing a processor to function as one or more components may be provided. In addition, a readable medium in which the program is recorded may be provided.

### Second Application Example of User Device

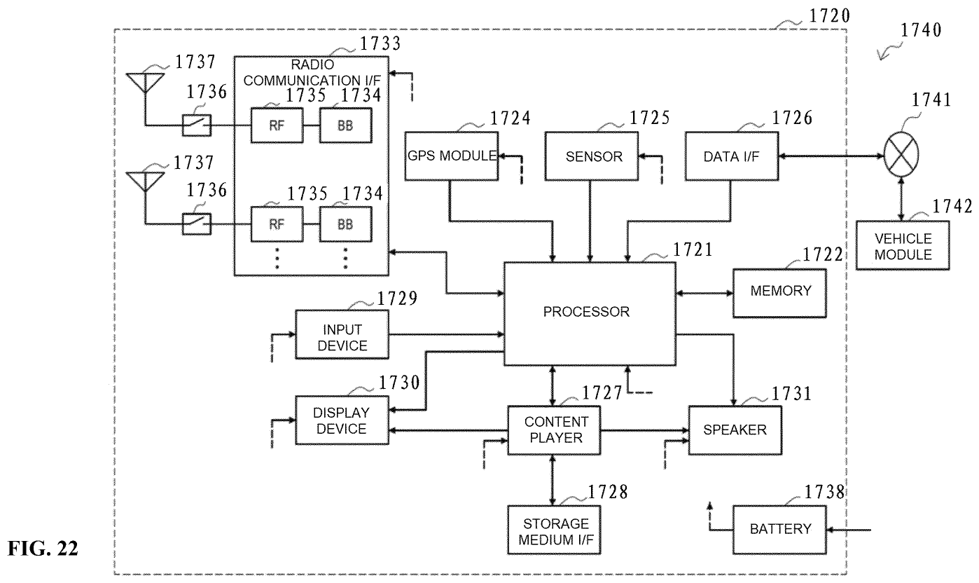

FIG. 22 is a block diagram showing an example of a schematic configuration of a car navigation device 1720 to which the technology of the present disclosure can be applied. The car navigation device 1720 can be implemented as the electronic device 200 described with reference to FIG. 18A. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, and a radio communication interface 1733, one or more antenna switches 1736, one or more antennas 1737, and a battery 1738.

The processor 1721 may be, for example, a CPU or a SoC, and controls navigation functions and other functions of the car navigation device 1720. The memory 1722 includes a RAM and a ROM, and stores data and programs executed by the processor 1721.

The GPS module 1724 uses a GPS signal received from a GPS satellite to measure the position (such as latitude, longitude, and altitude) of the car navigation device 1720. The sensor 1725 may include a set of sensors such as a gyroscope sensor, a geomagnetic sensor, and an air pressure sensor. The data interface 1726 is connected to, for example, an in-vehicle network 1741 via a terminal not shown, and acquires data (such as vehicle speed data) generated by the vehicle.

The content player 1727 reproduces content stored in a storage medium such as a CD and a DVD, which is inserted into the storage medium interface 1728. The input device 1729 includes, for example, a touch sensor, a button, or a switch configured to detect a touch on the screen of the display device 1730, and receives an operation or information input from a user. The display device 1730 includes a screen such as an LCD or OLED display, and displays an image of a navigation function or reproduced content. The speaker 1731 outputs the sound of the navigation function or the reproduced content.

The radio communication interface 1733 supports any cellular communication scheme such as 4G LTE or 5G NR, and performs wireless communication. The radio communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for wireless communication. Meanwhile, the RF circuit 1735 may include, for example, a mixer, a filter, and an amplifier, and transmit and receive wireless signals via the antenna 1737. The radio communication interface 1733 may also be a chip module on which a BB processor 1734 and an RF circuit 1735 are integrated. As shown in FIG. 22, the radio communication interface 1733 may include a plurality of BB processors 1734 and a plurality of RF circuits 1735. Although FIG. 22 shows an example in which the radio communication interface 1733 includes a plurality of BB processors 1734 and a plurality of RF circuits 1735, the radio communication interface 1733 may also include a single BB processor 1734 or a single RF circuit 1735.

In addition, in addition to the cellular communication scheme, the radio communication interface 1733 may support other types of wireless communication scheme, such as a short-range wireless communication scheme, a near field communication scheme, and a wireless LAN scheme. In this case, the radio communication interface 1733 may include a BB processor 1734 and an RF circuit 1735 for each wireless communication scheme.

Each of the antenna switches 1736 switches the connection destination of the antenna 1737 between a plurality of circuits included in the radio communication interface 1733, such as circuits for different wireless communication schemes.

The antennas 1737 includes multiple antenna elements, such as multiple antenna arrays for large-scale MIMO. The antennas 1737, for example, can be arranged into a matrix of antenna arrays, and are used by the radio communication interface 1733 to transmit and receive wireless signals.

In addition, the car navigation device 1720 may include an antenna 1737 for each wireless communication scheme. In this case, the antenna switch 1736 may be omitted from the configuration of the car navigation device 1720.

The battery 1738 supplies power to each block of the car navigation device 1720 shown in FIG. 22 via a feeder, and the feeder is partially shown as a dotted line in the figure. The battery 1738 accumulates power provided from the vehicle.

In the car navigation device 1720 shown in FIG. 22, one or more units included in the processing circuitry 201 described with reference to FIG. 18A may be implemented in the radio communication interface 1733. Alternatively, at least a part of these components may be implemented in the processor 1721. As an example, the car navigation device 1720 includes a part (for example, the BB processor 1734) or the whole of the radio communication interface 1733, and/or a module including the processor 1721, and one or more components may be implemented in the module. In this case, the module may store a program that allows processing to function as one or more components (in other words, a program for allowing the processor to perform operations of one or more components), and may execute the program. As another example, a program for allowing the processor to function as one or more components may be installed in the car navigation device 1720, and the radio communication interface 1733 (for example, the BB processor 1734) and/or the processor 1721 may Execute the procedure. As described above, as a device including one or more components, a car navigation device 1720 or a module may be provided, and a program for allowing the processor to function as one or more components may be provided. In addition, a readable medium in which the program is recorded may be provided.

In addition, in the car navigation device 1720 as shown in FIG. 22, for example, the communication unit 205 described with reference to FIG. 18A can be implemented in the radio communication interface 1733 (e.g., the RF circuit 1735).

The technology of the present disclosure may also be implemented as an in-vehicle system (or vehicle) 1740 including one or more of a car navigation device 1720, an in-vehicle network 1741, and a vehicle module 1742. The vehicle module 1742 generates vehicle data such as vehicle speed, engine speed, and failure information, and outputs the generated data to the in-vehicle network 1741.

Although the illustrative embodiments of the present disclosure have been described with reference to the accompanying drawings, the present disclosure is certainly not limited to the above examples. Those skilled in the art may achieve various adaptions and modifications within the scope of the appended claims, and it will be appreciated that these adaptions and modifications certainly fall into the scope of the technology of the present disclosure.

For example, in the above embodiments, the multiple functions included in one module may be implemented by separate means. Alternatively, in the above embodiments, the multiple functions included in multiple modules may be implemented by separate means, respectively. In additions, one of the above functions may be implemented by multiple modules. Needless to say, such configurations are included in the scope of the technology of the present disclosure.

In this specification, the steps described in the flowcharts include not only the processes performed sequentially in chronological order, but also the processes performed in parallel or separately but not necessarily performed in chronological order. Furthermore, even in the steps performed in chronological order, needless to say, the order may be changed appropriately.

Although the present disclosure and its advantages have been described in detail, it will be appreciated that various changes, replacements and transformations may be made without departing from the spirit and scope of the present disclosure as defined by the appended claims. In addition, the terms “include”, “comprise” or any other variants of the embodiments of the present disclosure are intended to be non-exclusive inclusion, such that the process, method, article or device including a series of elements includes not only these elements, but also those that are not listed specifically, or those that are inherent to the process, method, article or device. In case of further limitations, the element defined by the sentence “include one” does not exclude the presence of additional same elements in the process, method, article or device including this element.

1. An electronic device for a base station, comprising:
processing circuitry configured to
configure, via RRC signaling, a transmission configuration indication (TCI) state pool for a user equipment (UE);
activate, via MAC CE including a set of codepoints, TCI states in the TCI state pool for the UE, wherein each of the codepoints is capable of referencing any of
a) a single downlink TCI state for indicating a downlink beam:
b) a single uplink TCI state for indicating an uplink beam:
c) a single joint TCI state for indicating a downlink beam and an uplink beam: or
d) a pair of uplink TCI state and downlink TCI state; and
indicate, via a DCI pointing to one codepoint of the set of codepoints, use of a beam corresponding to a TCI state referenced by this codepoint to the UE.

2. The electronic device of claim 1, wherein the processing circuitry is further configured to configure, via the RRC signaling, whether each of the TCI states in the TCI state pool is a downlink TCI state, an uplink TCI state, or a joint TCI state.

3. The electronic device of claim 1, wherein the TCI state pool comprises a plurality of TCI state pools.

4. The electronic device of claim 3, wherein the plurality of TCI state pools comprise:
a first TCI state pool including uplink TCI states, and
a second TCI state pool including downlink TCI states,
wherein the TCI states in the first TCI state pool and in the second TCI state pool have different identification information from each other.

5. The electronic device of claim 4, wherein the processing circuitry is further configured to
reuse, via the MAC CE, one or more downlink TCI states in the second TCI state pool as joint TCI states.

6. The electronic device of claim 3, wherein the processing circuitry is further configured to
select, via a further MAC CE, a particular TCI state pool from the plurality of TCI state pools, and
wherein said MAC CE is used to activate TCI states in the particular TCI state pool.

7. The electronic device of claim 3, wherein the plurality of TCI state pools correspond to a plurality of cells.

8. The electronic device of claim 1, wherein each codepoint of the set of codepoints is capable to reference a single TCI state or a pair of uplink TCI state and downlink TCI state for each of a plurality of transmit and receive points (TRPs).

9. The electronic device of claim 1, wherein the processing circuitry is further configured to
send a further MAC CE to the UE, wherein the further MAC CE indicates which of a plurality of predefined combinations of channels or reference signals will share a common beam.

10. An electronic device for a user equipment (UE), comprising:
processing circuitry configured to
receive RRC signaling for configuration on a transmission configuration indication (TCI) state pool from a base station;
receive a MAC CE including a set of codepoints to activate TCI states in the TCI state pool from the base station, wherein each of the codepoints is capable to reference any of
a) a single downlink TCI state for indicating a downlink beam;
b) a single uplink TCI state for indicating an uplink beam:
c) a single joint TCI state for indicating a downlink beam and an uplink beam: or
d) a pair of uplink TCI state and downlink TCI state; and
receive a DCI pointing to one codepoint of the set of codepoints from the base station, so as to be indicated use of a beam corresponding to a TCI state referenced by the codepoint.

11. The electronic device of claim 10, wherein the RRC signaling further configures whether each of TCI states in the TCI state pool is a downlink TCI state, an uplink TCI state, or a joint TCI state.

12. The electronic device of claim 10, wherein the TCI state pool comprises a plurality of TCI state pools.

13. The electronic device of claim 12, wherein the plurality of pools of TCI states comprise:
a first TCI state pool including uplink TCI states; and
a second TCI state pool including downlink TCI state,
wherein identification information of the TCI states in the first TCI state pool and in the second TCI state pool are different from each other.

14. The electronic device of claim 12, the MAC CE reuses one or more downlink TCI states in the second TCI state pool as joint TCI states.

15. The electronic device of claim 12, the processing circuitry is further configured to:
receive a further MAC CE from the base station to select a particular TCI state pool from the plurality of TCI state pools,
wherein said MAC CE is used to activate TCI states in the particular TCI state pool.

16. The electronic device of claim 12, wherein the plurality of TCI state pools correspond to a plurality of cells, respectively.

17. The electronic device of claim 10, wherein each codepoint in the set of codepoints is capable of referencing a single TCI state or a pair of uplink and downlink TCI states for each of a plurality of transmit and receive points (TRPs).

18. The electronic device of claim 10, the processing circuitry is further configured to:
receive a further MAC CE from the base station, wherein the further MAC CE indicates which of a plurality of predefined combinations of channels or reference signals shares a common beam.

19. A communication method, comprising:
configuring, via RRC signaling, a transmission configuration indication (TCI) state pool for a user equipment (UE);
activating, via MAC CE including a set of codepoints, TCI states in the TCI state pool for the UE, wherein each of the codepoints is capable of referencing any of
a) a single downlink TCI state for indicating a downlink beam;
b) a single uplink TCI state for indicating an uplink beam;
c) a single joint TCI state for indicating a downlink beam and an uplink beam; or
d) a pair of uplink TCI state and downlink TCI state; and
indicating, via a DCI pointing to one codepoint of the set of codepoints, use of a beam corresponding to a TCI state referenced by this codepoint to the UE.

20. A communication method, comprising:
receiving RRC signaling for configuration on a transmission configuration indication (TCI) state pool from a base station;
receiving a MAC CE including a set of codepoints to activate TCI states in the TCI state pool from the base station, wherein each of the codepoints is capable to reference any of
a) a single downlink TCI state for indicating a downlink beam;
b) a single uplink TCI state for indicating an uplink beam;
c) a single joint TCI state for indicating a downlink beam and an uplink beam; or
d) a pair of uplink TCI state and downlink TCI state; and
receiving a DCI pointing to one codepoint of the set of codepoints from the base station, so as to be indicated use of a beam corresponding to a TCI state referenced by the codepoint.

21. A computer program product comprising executable instructions which, when executed, implement the communication method of claim 19.
